(19) United States
(12) Patent Application Publication
(10) Pub. No.: US 2023/0389010 A1
(43) Pub. Date: Nov. 30, 2023

(54) MULTIPLEXING OF UPLINK CONTROL INFORMATION (UCI) AND CONFIGURED GRANT-UCI (CG-UCI) OF DIFFERENT PRIORITIES

(71) Applicant: QUALCOMM Incorporated, San Diego, CA (US)

(72) Inventors: Shaozhen GUO, Beijing (CN); Changlong XU, Beijing (CN); Jing SUN, San Diego, CA (US); Xiaoxia ZHANG, San Diego, CA (US)

(21) Appl. No.: 18/042,248

(22) PCT Filed: Sep. 25, 2020
(86) PCT No.: PCT/CN2020/117748

§ 371 Date: Feb. 20, 2023

(51) Int. Cl. H04W 72/1268; H04W 72/21; H04W 72/566

(52) U.S. Cl. CPC H04W 72/1268; H04W 72/21; H04W 72/569

(57) ABSTRACT

Wireless communication systems and methods related to multiplexing of uplink control information (UCI) and configured grant-UCI (CG-UCI) of different priorities are provided. A user equipment (UE) determines that a first resource for an uplink transmission associated with a first priority at least partially overlaps with a second resource for a first configured grant-physical uplink shared channel (CG-PUSCH) transmission associated with a second priority different from the first priority. The UE determines whether the first priority is higher than the second priority. In response to determining whether the first priority is higher than the second priority, the UE transmits one of the uplink transmission in the first resource or the first CG-PUSCH transmission in the second resource and refrains from transmitting the other one of the uplink transmission in the first resource or the first CG-PUSCH transmission in the second resource.

### TECHNICAL FIELD

This application relates to wireless communication systems and methods, and more particularly to multiplexing of uplink control information (UCI) and configured grant-UCI (CG-UCI) of different priorities.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long-term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

One approach to avoiding collisions when communicating in a shared spectrum or an unlicensed spectrum is to use a listen-before-talk (LBT) procedure to ensure that the shared channel is clear before transmitting a signal in the shared channel. For example, a transmitting node may perform LBT to determine whether there are active transmissions in the channel. If the LBT results in an LBT pass, the transmitting node may transmit a preamble to reserve a channel occupancy time (COT) in the shared channel and may communicate with a receiving node during the COT.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a user equipment (UE), the method includes determining that a first resource for an uplink transmission associated with a first priority at least partially overlaps with a second resource for a first configured grant-physical uplink shared channel (CG-PUSCH) transmission associated with a second priority different from the first priority; determining whether the first priority is higher than the second priority; transmitting, in response to determining whether the first priority is higher than the second priority, one of the uplink transmission in the first resource or the first CG-PUSCH transmission in the second resource; and refraining, in response to determining whether the first priority is higher than the second priority, from transmitting the other one of the uplink transmission in the first resource or the first CG-PUSCH transmission in the second resource.

In an additional aspect of the disclosure, a method of wireless communication performed by a first user equipment (UE), the method includes determining that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission including configured grant-uplink control information (CG-UCI) and uplink data; multiplexing, in the first CG-PUSCH transmission, the first uplink transmission with the CG-UCI and the uplink data, the multiplexing being based on the first uplink transmission and the first CG-PUSCH transmission being associated with the first priority; determining whether the first priority is higher than the second priority; transmitting, in response to determining whether the first priority is higher than the second priority, one of the first CG-PUSCH transmission in the first resource or the second uplink transmission in a second resource associated with the second uplink transmission in the time period; and refraining, in response to determining whether the first priority is higher than the second priority, from transmitting the other one of the first CG-PUSCH transmission in the first resource or the second uplink transmission in the second resource.

In an additional aspect of the disclosure, a method of wireless communication performed by a first user equipment (UE), the method includes determining uplink control information (UCI) is in a time period that at least partially overlaps with a configured grant (CG) resource for a configured grant-physical uplink shared channel (CG-PUSCH) transmission including CG-UCI and uplink data; determining whether the UCI has a higher priority than the CG-PUSCH transmission; generating an uplink communication signal, where the generating includes multiplexing, in response to the determining whether the UCI has the higher priority than the CG-PUSCH transmission, the UCI with the CG-PUSCH transmission; and transmitting the uplink communication signal.

In an additional aspect of the disclosure, a method of wireless communication performed by a first user equipment (UE), the method includes determining a first uplink transmission associated with a first priority and a second uplink transmission associated with a second priority are in a time period that at least partially overlaps with a configured grant (CG) resource for a first configured grant-physical uplink shared channel (CG-PUSCH) transmission associated with the first priority, the first CG-PUSCH transmission including first configured grant-uplink control information (CG-UCI) and first uplink data; generating an uplink communication signal, where the generating includes multiplexing, in the first CG-PUSCH transmission, the first uplink transmission with the first CG-UCI and the first uplink data, the multiplexing being based on the first uplink transmission and the first CG-PUSCH transmission being associated with the first priority; determining whether the first priority is higher than the second priority; multiplexing, in response to the determining whether the first priority is higher than the second priority, the first CG-PUSCH transmission with the second uplink transmission after multiplexing the first uplink transmission with the first CG-UCI and uplink data; and transmitting the uplink communication signal.

In an additional aspect of the disclosure, a method of wireless communication performed by a first user equipment (UE), the method includes determining one or more uplink control information (UCI) messages are in a time period that at least partially overlaps with a first configured grant (CG) resource for a first configured grant-physical uplink shared channel (CG-PUSCH) transmission including first configured grant-uplink control information (CG-UCI) and first uplink data, where at least a first UCI message of the one or more UCI messages is associated with a first traffic priority, and where the CG-PUSCH transmission is associated with a second traffic priority different from the first traffic priority; generating an uplink communication signal, where the generating includes multiplexing, in the CG-PUSCH transmission, the one or more UCI messages with the first CG-UCI and the uplink data based on a multiplexing priority order; and transmitting the uplink communication signal in the first CG resource.

In an additional aspect of the disclosure, a method of wireless communication performed by a base station (BS), the method includes transmitting, to a user equipment (UE), a multiplex configuration associated with a configured grant (CG) resource and first hybrid automatic repeat request-acknowledgment (HARQ-ACK) information of different priorities, the multiplex configuration including a multiplex disabling indicator or a multiplex enabling indicator; receiving a first uplink communication signal including the HARQ-ACK information or CG uplink data in response to transmitting the multiplexing configuration including the multiplex disabling indicator; and receiving a second uplink communication signal including the CG uplink data multiplexed with the HARQ-ACK information in response to transmitting the multiplexing configuration including the multiplex enabling indicator.

In an additional aspect of the disclosure, a user equipment (UE) includes a processor configured to determine that a first resource for an uplink transmission associated with a first priority at least partially overlaps with a second resource for a first configured grant-physical uplink shared channel (CG-PUSCH) transmission associated with a second priority different from the first priority; and determine whether the first priority is higher than the second priority; and a transceiver configured to transmit, in response to determining whether the first priority is higher than the second priority, one of the uplink transmission in the first resource or the first CG-PUSCH transmission in the second resource; and refrain, in response to determining whether the first priority is higher than the second priority, from transmitting the other one of the uplink transmission in the first resource or the first CG-PUSCH transmission in the second resource.

In an additional aspect of the disclosure, a user equipment (UE) includes a processor configured to determine that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission including configured grant-uplink control information (CG-UCI) and uplink data; multiplex, in the first CG-PUSCH transmission, the first uplink transmission with the CG-UCI and the uplink data, the multiplexing being based on the first uplink transmission and the first CG-PUSCH transmission being associated with the first priority; determine whether the first priority is higher than the second priority; and a transceiver configured to transmit, in response to determining whether the first priority is higher than the second priority, one of the first CG-PUSCH transmission in the first resource or the second uplink transmission in a second resource associated with the second uplink transmission in the time period; and refrain, in response to determining whether the first priority is higher than the second priority, from transmitting the other one of the first CG-PUSCH transmission in the first resource or the second uplink transmission in the second resource.

In an additional aspect of the disclosure, a user equipment (UE) includes a processor configured to determine uplink control information (UCI) is in a time period that at least partially overlaps with a configured grant (CG) resource for a configured grant-physical uplink shared channel (CG-PUSCH) transmission including CG-UCI and uplink data; determine whether the UCI has a higher priority than the CG-PUSCH transmission; and generate an uplink communication signal by multiplexing, in response to the determining whether the UCI has the higher priority than the CG-PUSCH transmission, the UCI with the CG-PUSCH transmission; and a transceiver configured to transmit the uplink communication signal.

In an additional aspect of the disclosure, a user equipment (UE) includes a processor configured to determine a first uplink transmission associated with a first priority and a second uplink transmission associated with a second priority are in a time period that at least partially overlaps with a configured grant (CG) resource for a first configured grant-physical uplink shared channel (CG-PUSCH) transmission associated with the first priority, the first CG-PUSCH transmission including first configured grant-uplink control information (CG-UCI) and first uplink data; generate an uplink communication signal by multiplexing, in the first CG-PUSCH transmission, the first uplink transmission with the first CG-UCI and the first uplink data, the multiplexing being based on the first uplink transmission and the first CG-PUSCH transmission being associated with the first priority; determine whether the first priority is higher than the second priority; and multiplex, in response to the determining whether the first priority is higher than the second priority, the first CG-PUSCH transmission with the second uplink transmission after multiplexing the first uplink transmission with the first CG-UCI and uplink data; and a transceiver configured to transmit the uplink communication signal.

In an additional aspect of the disclosure, a user equipment (UE) includes a processor configured to determine one or more uplink control information (UCI) messages are in a time period that at least partially overlaps with a first configured grant (CG) resource for a first configured grant-physical uplink shared channel (CG-PUSCH) transmission including first configured grant-uplink control information (CG-UCI) and first uplink data, where at least a first UCI message of the one or more UCI messages is associated with a first traffic priority, and where the CG-PUSCH transmission is associated with a second traffic priority different from the first traffic priority; and generate an uplink communication signal by multiplexing, in the CG-PUSCH transmission, the one or more UCI messages with the first CG-UCI and the uplink data based on a multiplexing priority order; and a transceiver configured to transmit the uplink communication signal in the first CG resource.

In an additional aspect of the disclosure, a base station (BS) includes a transceiver configured to transmit, to a user equipment (UE), a multiplex configuration associated with a configured grant (CG) resource and first hybrid automatic repeat request-acknowledgment (HARQ-ACK) information of different priorities, the multiplex configuration including a multiplex disabling indicator or a multiplex enabling indicator; receive a first uplink communication signal including the HARQ-ACK information or CG uplink data in response to transmitting the multiplexing configuration including the multiplex disabling indicator; and receive a second uplink communication signal including the CG uplink data multiplexed with the HARQ-ACK information in response to transmitting the multiplexing configuration including the multiplex enabling indicator.

In an additional aspect of the disclosure, a non-transitory computer-readable medium having program code recorded thereon, the program code includes code for causing a user equipment (UE) to determine that a first resource for an uplink transmission associated with a first priority at least partially overlaps with a second resource for a first configured grant-physical uplink shared channel (CG-PUSCH) transmission associated with a second priority different from the first priority; and code for causing the UE to determine whether the first priority is higher than the second priority; code for causing the UE to transmit, in response to determining whether the first priority is higher than the second priority, one of the uplink transmission in the first resource or the first CG-PUSCH transmission in the second resource; and code for causing the UE to refrain, in response to determining whether the first priority is higher than the second priority, from transmitting the other one of the uplink transmission in the first resource or the first CG-PUSCH transmission in the second resource.

In an additional aspect of the disclosure, a non-transitory computer-readable medium having program code recorded thereon, the program code includes code for causing a user equipment (UE) to determine that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission including configured grant-uplink control information (CG-UCI) and uplink data; multiplex, in the first CG-PUSCH transmission, the first uplink transmission with the CG-UCI and the uplink data, the multiplexing being based on the first uplink transmission and the first CG-PUSCH transmission being associated with the first priority; determine whether the first priority is higher than the second priority; and a transceiver configured to transmit, in response to determining whether the first priority is higher than the second priority, one of the first CG-PUSCH transmission in the first resource or the second uplink transmission in a second resource associated with the second uplink transmission in the time period; and refrain, in response to determining whether the first priority is higher than the second priority, from transmitting the other one of the first CG-PUSCH transmission in the first resource or the second uplink transmission in the second resource.

In an additional aspect of the disclosure, a non-transitory computer-readable medium having program code recorded thereon, the program code includes code for causing a user equipment (UE) to determine uplink control information (UCI) is in a time period that at least partially overlaps with a configured grant (CG) resource for a configured grant-physical uplink shared channel (CG-PUSCH) transmission including CG-UCI and uplink data; code for causing the UE to determine whether the UCI has a higher priority than the CG-PUSCH transmission; code for causing the UE to generate an uplink communication signal by multiplexing, in response to the determining whether the UCI has the higher priority than the CG-PUSCH transmission, the UCI with the CG-PUSCH transmission; and code for causing the UE to transmit the uplink communication signal.

In an additional aspect of the disclosure, a non-transitory computer-readable medium having program code recorded thereon, the program code includes code for causing a user equipment (UE) to determine a first uplink transmission associated with a first priority and a second uplink transmission associated with a second priority are in a time period that at least partially overlaps with a configured grant (CG) resource for a first configured grant-physical uplink shared channel (CG-PUSCH) transmission associated with the first priority, the first CG-PUSCH transmission including first configured grant-uplink control information (CG-UCI) and first uplink data; code for causing the UE to generate an uplink communication signal by multiplexing, in the first CG-PUSCH transmission, the first uplink transmission with the first CG-UCI and the first uplink data, the multiplexing being based on the first uplink transmission and the first CG-PUSCH transmission being associated with the first priority; code for causing the UE to determine whether the first priority is higher than the second priority; code for causing the UE to multiplex, in response to the determining whether the first priority is higher than the second priority, the first CG-PUSCH transmission with the second uplink transmission after multiplexing the first uplink transmission with the first CG-UCI and uplink data; and code for causing the UE to transmit the uplink communication signal.

In an additional aspect of the disclosure, a non-transitory computer-readable medium having program code recorded thereon, the program code includes code for causing a user equipment (UE) to determine one or more uplink control information (UCI) messages are in a time period that at least partially overlaps with a first configured grant (CG) resource for a first configured grant-physical uplink shared channel (CG-PUSCH) transmission including first configured grant-uplink control information (CG-UCI) and first uplink data, where at least a first UCI message of the one or more UCI messages is associated with a first traffic priority, and where the CG-PUSCH transmission is associated with a second traffic priority different from the first traffic priority; code for causing the UE to generate an uplink communication signal by multiplexing, in the CG-PUSCH transmission, the one or more UCI messages with the first CG-UCI and the uplink data based on a multiplexing priority order; and code for causing the UE to transmit the uplink communication signal in the first CG resource.

In an additional aspect of the disclosure, a non-transitory computer-readable medium having program code recorded thereon, the program code includes code for causing a base station (BS) to transmit, to a user equipment (UE), a multiplex configuration associated with a configured grant (CG) resource and first hybrid automatic repeat request-acknowledgment (HARQ-ACK) information of different priorities, the multiplex configuration including a multiplex disabling indicator or a multiplex enabling indicator; code for causing the BS to receive a first uplink communication signal including the HARQ-ACK information or CG uplink data in response to transmitting the multiplexing configuration including the multiplex disabling indicator; and code for causing the BS to receive a second uplink communication signal including the CG uplink data multiplexed with the HARQ-ACK information in response to transmitting the multiplexing configuration including the multiplex enabling indicator.

In an additional aspect of the disclosure, a user equipment (UE) includes means for determining that a first resource for an uplink transmission associated with a first priority at least partially overlaps with a second resource for a first configured grant-physical uplink shared channel (CG-PUSCH) transmission associated with a second priority different from the first priority; and means for determining whether the first priority is higher than the second priority; means for transmitting, in response to determining whether the first priority is higher than the second priority, one of the uplink transmission in the first resource or the first CG-PUSCH transmission in the second resource; and means for refraining, in response to determining whether the first priority is higher than the second priority, from transmitting the other one of the uplink transmission in the first resource or the first CG-PUSCH transmission in the second resource.

In an additional aspect of the disclosure, a user equipment (UE) includes means for determining that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission including configured grant-uplink control information (CG-UCI) and uplink data; means for multiplexing, in the first CG-PUSCH transmission, the first uplink transmission with the CG-UCI and the uplink data, the multiplexing being based on the first uplink transmission and the first CG-PUSCH transmission being associated with the first priority means for determining whether the first priority is higher than the second priority; and means for transmitting, in response to determining whether the first priority is higher than the second priority, one of the first CG-PUSCH transmission in the first resource or the second uplink transmission in a second resource associated with the second uplink transmission in the time period; and means for refraining, in response to determining whether the first priority is higher than the second priority, from transmitting the other one of the first CG-PUSCH transmission in the first resource or the second uplink transmission in the second resource.

In an additional aspect of the disclosure, a user equipment (UE) includes means for determining uplink control information (UCI) is in a time period that at least partially overlaps with a configured grant (CG) resource for a configured grant-physical uplink shared channel (CG-PUSCH) transmission including CG-UCI and uplink data; means for determining whether the UCI has a higher priority than the CG-PUSCH transmission; means for generating an uplink communication signal by multiplexing, in response to the determining whether the UCI has the higher priority than the CG-PUSCH transmission, the UCI with the CG-PUSCH transmission; and means for transmitting the uplink communication signal.

In an additional aspect of the disclosure, a user equipment (UE) includes means for determining a first uplink transmission associated with a first priority and a second uplink transmission associated with a second priority are in a time period that at least partially overlaps with a configured grant (CG) resource for a first configured grant-physical uplink shared channel (CG-PUSCH) transmission associated with the first priority, the first CG-PUSCH transmission including first configured grant-uplink control information (CG-UCI) and first uplink data; means for generating an uplink communication signal by multiplexing, in the first CG-PUSCH transmission, the first uplink transmission with the first CG-UCI and the first uplink data, the multiplexing being based on the first uplink transmission and the first CG-PUSCH transmission being associated with the first priority; means for determining whether the first priority is higher than the second priority; means for multiplexing, in response to the determining whether the first priority is higher than the second priority, the first CG-PUSCH transmission with the second uplink transmission after multiplexing the first uplink transmission with the first CG-UCI and uplink data; and means for transmitting the uplink communication signal.

In an additional aspect of the disclosure, a user equipment (UE) includes means for determining one or more uplink control information (UCI) messages are in a time period that at least partially overlaps with a first configured grant (CG) resource for a first configured grant-physical uplink shared channel (CG-PUSCH) transmission including first configured grant-uplink control information (CG-UCI) and first uplink data, where at least a first UCI message of the one or more UCI messages is associated with a first traffic priority, and where the CG-PUSCH transmission is associated with a second traffic priority different from the first traffic priority; means for generating an uplink communication signal by multiplexing, in the CG-PUSCH transmission, the one or more UCI messages with the first CG-UCI and the uplink data based on a multiplexing priority order; and means for transmitting the uplink communication signal in the first CG resource.

In an additional aspect of the disclosure, a base station (BS) includes means for transmitting, to a user equipment (UE), a multiplex configuration associated with a configured grant (CG) resource and first hybrid automatic repeat request-acknowledgment (HARQ-ACK) information of different priorities, the multiplex configuration including a multiplex disabling indicator or a multiplex enabling indicator; means for receiving a first uplink communication signal including the HARQ-ACK information or CG uplink data in response to transmitting the multiplexing configuration including the multiplex disabling indicator; and means for receiving a second uplink communication signal including the CG uplink data multiplexed with the HARQ-ACK information in response to transmitting the multiplexing configuration including the multiplex enabling indicator.

Other aspects and features aspect of the present invention will become apparent to those of ordinary skill in the art, upon reviewing the following description of specific, exemplary aspects of the present invention in conjunction with the accompanying figures. While features of the present invention may be discussed relative to certain aspects and figures below, all aspects of the present invention can include one or more of the advantageous features discussed herein. In other words, while one or more aspects may be discussed as having certain advantageous features, one or more of such features may also be used in accordance with the various aspects of the invention discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a scheduling/configuration timeline according to one or more aspects of the present disclosure.

FIG. 4 illustrates a communication scheme for handling collision between configured grant-uplink control information (CG-UCI) and scheduled UCI of different priorities according to one or more aspects of the present disclosure.

FIG. 5 illustrates a communication scheme for handling collision between CG-UCI and scheduled UCI of different priorities according to one or more aspects of the present disclosure.

FIG. 6 illustrates a communication scheme for handling collision between CG-UCI and scheduled UCI of different priorities according to one or more aspects of the present disclosure.

FIG. 7 illustrates a communication scheme for handling collision between CG-UCI and scheduled UCI of different priorities according to one or more aspects of the present disclosure.

FIG. 8 illustrates a communication scheme for handling collision between CG-UCI and scheduled UCI of different priorities according to one or more aspects of the present disclosure.

FIG. 9 illustrates a communication scheme for handling collision between CG-UCI and scheduled UCI of different priorities according to one or more aspects of the present disclosure.

FIG. 10 illustrates a communication scheme for handling collision between CG-UCI and scheduled UCI of different priorities according to one or more aspects of the present disclosure.

FIG. 11 illustrates a communication scheme for handling collision between CG-UCI and scheduled UCI of different priorities according to one or more aspects of the present disclosure.

FIG. 12 illustrates a communication scheme for handling collision between CG-UCI and scheduled UCI of different priorities according to one or more aspects of the present disclosure.

FIG. 13 illustrates a communication scheme for handling collision between CG-UCI and scheduled UCI of different priorities according to one or more aspects of the present disclosure.

FIG. 14 illustrates a communication scheme for handling collision between CG-UCI and scheduled UCI of different priorities according to one or more aspects of the present disclosure.

FIG. 15 illustrates a communication scheme for handling collision between CG-UCI and scheduled UCI of different priorities according to one or more aspects of the present disclosure.

FIG. 16 illustrates a communication scheme for handling collision between CG-UCI and scheduled UCI of different priorities according to one or more aspects of the present disclosure.

FIG. 17 illustrates a communication scheme for handling collision between CG-UCI and scheduled UCI of different priorities according to one or more aspects of the present disclosure.

FIG. 18 is a flow diagram of a communication method for handling collision between CG-UCI and scheduled UCI of different priorities according to some aspects of the present disclosure.

FIG. 19 is a block diagram of an exemplary user equipment (UE) according to some aspects of the present disclosure.

FIG. 20 is a block diagram of an exemplary base station (BS) according to some aspects of the present disclosure.

FIG. 21 is a flow diagram of a communication method according to some aspects of the present disclosure.

FIG. 22 is a flow diagram of a communication method according to some aspects of the present disclosure.

FIG. 23 is a flow diagram of a communication method according to some aspects of the present disclosure.

FIG. 24 is a flow diagram of a communication method according to some aspects of the present disclosure.

FIG. 25 is a flow diagram of a communication method according to some aspects of the present disclosure.

FIG. 26 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a wireless communication network, a base station (BS) may schedule a user equipment (UE) for UL and/or DL communications via a dynamic scheduling or a configured grant (CG) procedure. For dynamic scheduling, the BS may transmit a scheduling assignment or grant to schedule the UE for each and every UL transmission and/or each and every DL transmission. On the other hand, for CG-based transmissions, the BS may configure the UE with a set of resources, which may be referred to as CG resources, and the UE may transmit or receive in any of the CG resources without receiving a specific scheduling grant from the BS for each CG resource. There are two types of CGs, a CG type 1 and a CG type 2. For a CG type 1, the BS may preconfigure the UE with a CG configuration indicating an allocated resource and a periodicity for the allocated resource. For a CG type 2, the BS may preconfigure the UE with a CG configuration indicating a periodicity. The BS may activate the CG configuration by indicating a resource allocation for the CG configuration. Once activated, the resource allocation may repeat according to the preconfigured periodicity. In some instances, a CG transmission in a CG resource may also be referred to as a grant-less transmission, a grant-free transmission an unscheduled transmission, or an autonomous transmission.

Since the UE may transmit an uplink CG transmission (e.g., a CG-physical uplink shared channel (PUSCH) transmission) in a CG resource without receiving a scheduling grant from the BS, the UE may include CG-UCI in each CG transmission to facilitate reception and/or decoding of the CG transmission at the BS. For instance, the CG-UCI may indicate hybrid automatic repeat request (HARQ) information, such as a HARQ identifier (ID), a new data indicator (NDI), and/or a revision (RV) ID, related to the CG uplink data in the CG transmission. In some instances, the UE may transmit the CG transmission over a shared radio frequency band (e.g., in a shared spectrum or an unlicensed spectrum), and thus the UE may perform a listen-before-talk (LBT) to contend for a channel occupancy time (COT) in the shared channel. Upon gaining the COT, the UE may transmit the CG-transmission during a portion of the COT and may share a remaining portion with a BS. To indicate that the COT is for sharing, the UE may further include COT sharing information the CG-UCI.

The deployment of NR over an unlicensed band, for example, at about 3.5 gigahertz (GHz), sub-6 GHz or higher frequencies in the mmWav band, may be referred to as NR-U. In some aspects, it may be desirable for a BS to communicate ultra-reliable low-latency communication (URLLC) with a UE using both dynamic scheduling and a configured grant procedure. For URLLC in NR-U, the BS may assign a two-level priority (e.g., a high traffic priority or a low traffic priority) for each scheduled UCI transmission and a two-level priority for each CG-PUSCH transmission including CG-UCI. In some instances, a resource scheduled for a UCI transmission may partially overlaps with an uplink CG resource or fully overlaps with an uplink CG resource. Some examples of scheduled UCI transmissions may include, but not limited to, hybrid automatic repeat request-acknowledgement (HARQ-ACK) information and/or channel state information (CSI) reports. A CSI report may include information related to CSI-RS resource indicator (CRI), rank indicator (RI), layer indicator (LI), wideband channel quality indicator (CQI), and/or subband differential CQI, and/or precoding matrix indicator (PMI), determined based on a reference signal (e.g., a CSI-RS) in a DL communication. In some instances, a CSI report may be divided into a CSI part 1 and a CSI part 2, where the CSI part 1 may include RI, CRI, and/or CQI, and the CSI part 2 may include PMI and/or subband differential CQI. In some instances, the CSI may be periodic CSI, configured via a RRC configuration, or semi-persistent CSI activated via a medium access control (MAC) control element (CE) by a BS.

As used herein, the term “UCI” can refer to UCI scheduled by a BS via a dynamic scheduling grant (e.g., downlink control information (DCI)) and/or UCI (e.g., CSI) configured by a BS via RRC or MAC CE for transmission in a physical uplink control channel (PUCCH). As used herein, the term “CG-UCI” can refer to control information include in a CG-PUSCH transmission for providing information related to CG UL data (unscheduled data) in the CG-PUSCH transmission.

In some instances, a UE may receive a UCI transmission schedule in a time period that partially or fully overlaps with an uplink CG resource for a CG-PUSCH transmission including CG-UCI. In other words, the UCI transmission may collide with the CG-PUSCH transmission. There are various rules for handling collisions between a scheduled UCI transmission and a CG-PUSCH transmission including CG-UCI. However, the rules are limited to handling collision between scheduled UCI and CG-UCI of the same traffic priorities.

The present disclosure describes mechanisms for multiplexing UCI and CG-UCI of different traffic priorities. For example, a BS may schedule a UE for UL communication via dynamic scheduling grants. The UL communications may include PUSCH transmissions carrying UL data and/or PUCCH transmissions carrying UCI (e.g., HARQ-ACK information). Each scheduling grant may indicate a traffic priority (e.g., a low priority or a high priority) for a corresponding UL transmission. The BS may also configure the UE with PUCCH resources for CSI reporting (e.g., UCI), which may be of a low traffic priority. The BS may further configure the UE with CG grants indicating CG resources for UL communications (e.g., CG-PUSCH transmissions). Each configured grant may also indicate a traffic priority (e.g., a low priority or a high priority) for a corresponding CG resource. A CG-PUSCH transmission may include CG UL data (unscheduled UL data) and CG-UCI providing information (e.g., HARQ process ID, RV, NDI) related to the CG UL data. In some aspects, the UE may determine that a UCI message (e.g., including HARQ-ACK information) associated with a first priority is scheduled in a time period that at least partially overlaps (collides) with a CG resource for a CG-PUSCH transmission associated with a second priority different from the first priority. In some aspects, the UE may resolve the collision by refraining from transmitting (dropping) a lower priority transmission between the UCI message and the CG-PUSCH transmission and transmit a higher priority transmission between the UCI message and the CG-PUSCH transmission. In some other aspects, the UE may resolve the collision by multiplexing the UCI message of the first priority and CG-UCI and UL data of the second, different priority in the CG-PUSCH transmission and transmit the multiplexed CG-PUSCH transmission. In some aspects, the BS may configure the UE with a multiplex configuration for multiplexing HARQ-ACK information and CG-UCI of different priorities. The configuration may enable or disable multiplexing HARQ-ACK information and CG-UCI of different priorities, and the UE may determine whether to drop a lower priority transmission or multiplex the different priority UCI and CG-PUSCH transmissions based on the configuration.

In some aspect, the UE may determine that multiple UCI messages are scheduled in a time period that at least partially overlaps (collides) with a first CG resource for a first CG-PUSCH transmission associated with a high priority or a low priority. The multiple UCI message may include high-priority (HP) HARQ-ACK information and at least one of low-priority (LP) HARQ-ACK information and/or LP CSI. The first CG-PUSCH transmission may include including CG-UCI and CG UL data. The UE may resolve the collision by multiplexing among transmissions of the same priority before dropping a lower priority transmission or multiplexing across transmissions of different priorities. In some aspects, the UE may resolve the collision by multiplexing the UCI messages, the CG-UCI, the CG UL data according to a multiplexing priority order decoupled from the traffic priorities of the UCI messages, the CG-UCI, and the CG UL data.

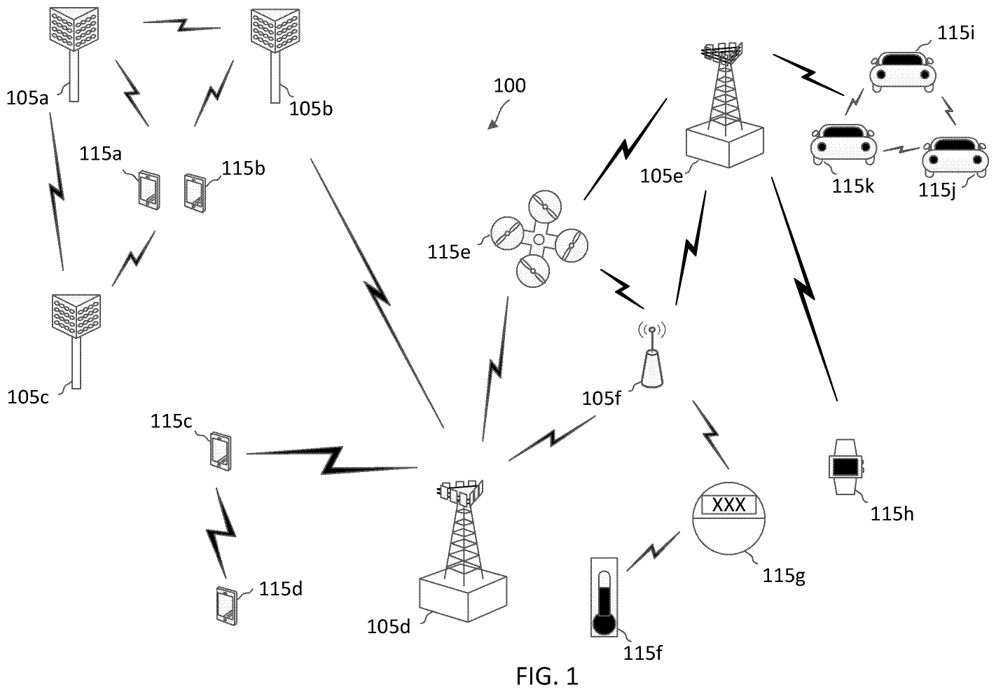

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. ABS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a back-off indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as channel occupancy time (COT). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. An LBT may include one, two, or more clear channel assessments (CCAs) performed during successive time periods. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random back-off period. For instance, a transmitting node may determine a channel measurement in a time interval and determine whether the channel is available or not based on a comparison of the channel measurement against a ED threshold. A CAT4 LBT refers to an LBT with a random back-off and a variable contention window (CW). For instance, a transmitting node may draw a random number and back-off for a duration based on the drawn random number in a certain time unit.

In some aspects, a BS 105 may utilize both dynamic scheduling and a CG procedure for communications with a UE 115. For dynamic scheduling, the BS 105 may transmit a scheduling assignment or grant to schedule the UE 115 for each and every UL transmission and/or each and every DL transmission. For CG-based communications, the BS 105 may configure the UE 115 with a set of resources, which may be referred to as CG resources, and the UE 115 may transmit or receive in any of the CG resources without receiving a specific scheduling grant from the BS 105 for each CG resource.

In some aspects, the network 100 may provision for URLLC, for example, over an unlicensed band. The network 100 may provision for two traffic priority levels (e.g., a high priority and a low priority) for UCI transmissions and two traffic two traffic priority levels (e.g., a high priority and a low priority) for CG-PUSCH transmissions. As discussed above, each CG transmission may include CG-UCI. In some instances, a UE 115 may receive a UCI transmission schedule in a time period that partially or fully overlaps with an uplink CG resource for a CG-PUSCH transmission including CG-UCI.

According to an aspect of the present disclosure, when a UE 115 determines that a first resource for an uplink transmission (e.g., a UCI transmission or a CG-PUSCH transmission) associated with a first priority (e.g., a traffic priority) at least partially overlaps with a second resource for a CG-PUSCH transmission associated with a second priority (e.g., a traffic priority) different from the first priority, the UE 115 may determine whether the first priority is higher than the second priority. If the UE 115 determines that the first priority is higher than the second priority, the UE 115 may transmit the uplink transmission in the first resource and drop the CG-PUSCH transmission (e.g., refrain from transmitting the CG-PUSCH transmission in the second resource). However, if the UE 115 determines that the first priority is lower than the second priority, the UE 115 may transmit the CG-PUSCH transmission in the second resource and drop the uplink transmission (e.g., refrain from transmitting the uplink transmission in the second resource). In another aspect, the UE 115 may multiplex the uplink transmission and the CG-PUSCH transmission of the different priorities according to a set of multiplexing rules. Mechanisms for handling a resource overlap or a collision between a UCI transmission and a CG-PUSCH transmission (including CG-UCI) of different traffic priorities are discussed in greater detail herein.

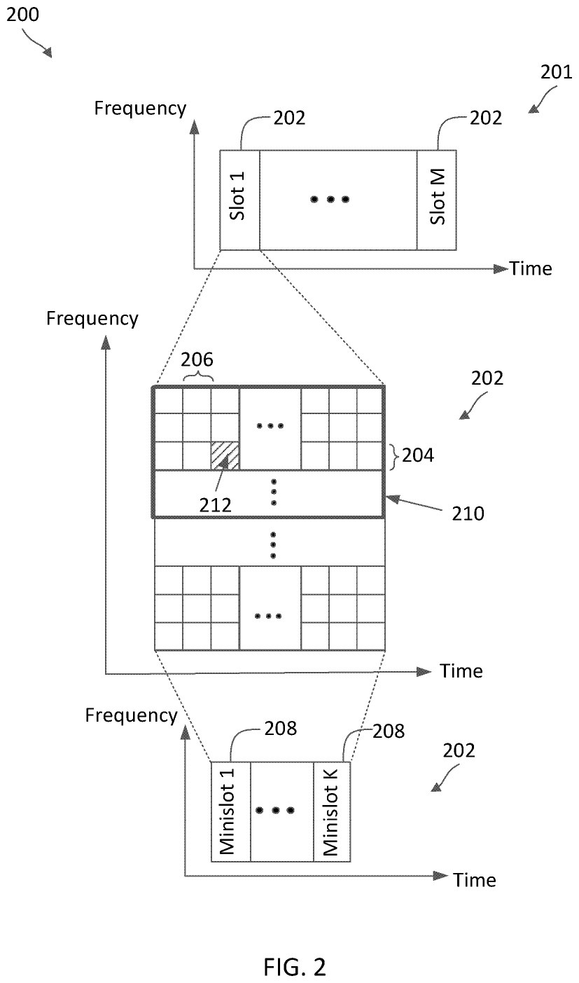

FIG. 2 illustrates a radio frame structure 200 according to some aspects of the present disclosure. The radio frame structure 200 may be employed by BSs such as the BSs 105 and UEs such as the UEs 115 in a network such as the network 100 for communications. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and one or more consecutive symbols 206 in time. In NR, a RB 210 is defined as twelve consecutive subcarriers 204 in a frequency domain.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

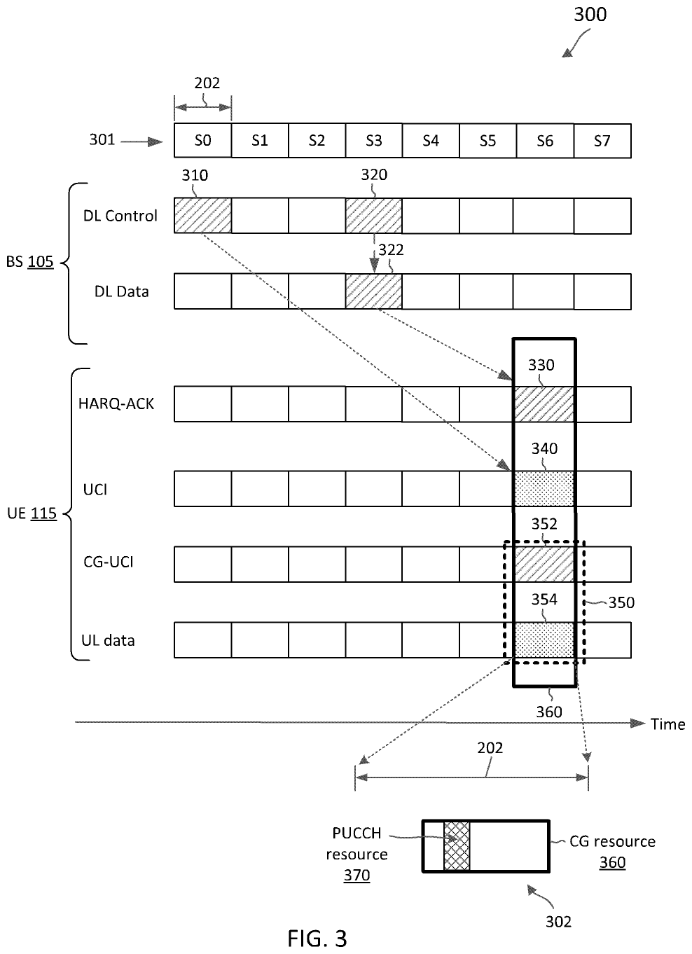

FIG. 3 illustrates a scheduling/configuration timeline 300 according to one or more aspects of the present disclosure. The scheduling/configuration timeline 300 may correspond to a scheduling/configuration timeline communicated between a BS 105 and a UE 115 of the network 100. In FIG. 3, the x-axis represents time in some constant units. FIG. 3 shows a frame structure 301, which may correspond to a portion of the frame structure 200 of FIG. 2. As shown, the frame structure 301 includes a plurality of slots 202 in time. The slots 202 are indexed from S0 to S9. For instance, a BS 105 may communicate with a UE 115 in units of slots 202. The slots 202 may also be referred to as transmission time intervals (TTIs). Each slot 202 or TTI carry a medium access control (MAC) layer transport block. Each slot 202 may include a number of symbols in time and a number of frequency tones in frequency. Each slot 202 may include a DL control portion followed by at least one of a subsequent DL data portion, UL data portion, and/or a UL control portion. In the context of LTE or NR, the DL control portion, the DL data portion, the UL data portion, and the UL control portion may be referred to as a physical downlink control channel (PDCCH), a physical downlink shared channel (PDSCH), a physical uplink shared channel (PUSCH), and a physical uplink control channel (PUCCH), respectively.

The pattern-filled boxes represent transmissions of DL control information (DCI), DL data, UL control information (UCI), UL data, an ACK, and/or a NACK in corresponding slots 202. While an entire slot 202 is pattern-filled, a transmission may occur only in a corresponding portion of the slot 202. As shown, the BS 105 transmits DCI 310 in the slot 202 indexed S0 (e.g., in a DL control portion of the slot 202). The DCI 310 may indicate a UL grant for the UE 115. The UE 115 transmits the UCI 340 to the BS 105 in the slot 202 indexed S6 (e.g., in a UL control portion of the slot 204) based on the UL assignment or RRC configuration or MAC CE. The slot 202 indexed S4 is a fourth slot from the slot 202 indexed S0. In an example, the UCI 340 may be a CSI report which is configured by RRC or activated by medium access control (MAC) control element (CE). As discussed above, a CSI report may include a CSI part 1 and a CSI part 2. Thus, in some instances, the UCI 340 may include CSI part 1 (e.g., including an RI, a CRI, and/or a wideband CQI) and CSI part 2 (e.g., PMI and/or a subband CQI).

Further, the BS 105 transmits DCI 320 in the slot 202 indexed S3 (e.g., in a DL control portion of the slot 202). The DCI 320 may indicate a DL grant for the UE 115 in the same slot 202 indexed S3. Thus, the BS 105 transmits a DL data signal 322 to the UE 115 in the slot 202 indexed S3 (e.g., in a DL data portion of the slot 202). The UE 115 may receive the DCI 320 and receive the DL data signal 322 based on the DL grant. The DL data signal 322 is a scheduled DL, which is granted by a DL grant indicated in the DCI 320.

In some aspects, the BS 105 may employ HARQ techniques as discussed above in relation to FIG. 1 for the transmission of the DL data signal 322. Accordingly, after receiving the DL data signal 322, the UE 115 may report a reception status of the DL data signal 322 to the BS 105 by transmitting HARQ-ACK information 330. The HARQ-ACK information 330 refers to a feedback of an ACK or a NACK. The feedback may be an ACK indicating that reception of the DL data by the UE 115 is successful or may be an NACK indicating that reception of the DL data by the UE 115 is unsuccessful (e.g., including an error or failing an error correction). In some aspects, the DCI 320 may also indicate a resource for transmitting the HARQ-ACK information 330 for the DL data signal 322. In the example illustrated in FIG. 3, the HARQ-ACK resource is in the slot 202 indexed S6.

As discussed above, the BS 105 may also configure the UE 115 with a configured grant for UL transmissions. A configured UL transmission is an unscheduled transmission, performed on the channel without a UL grant. A configured UL transmission may also be referred to as a grantless, grant-free, or autonomous transmission. In some examples, the UE may transmit a UL control information and/or UL data based on a configured grant. Additionally, configured-UL data may also be referred to as grantless UL data, grant-free UL data, unscheduled UL data, or autonomous UL (AUL) data. Additionally, a configured grant may also be referred to as a grant-free grant, unscheduled grant, or autonomous grant. The resources and other parameters used by the UE for a configured grant transmission may be provided by the BS in one or more of a RRC configurations or an activation DCI, without an explicit grant for each UL transmission.

For instance, the BS 105 may configure the UE 115 with an UL configured grant indicating a CG resource (e.g., a time-frequency resource) that repeats in time according to a certain periodicity (e.g., about 5 ms, 10 ms, 20 ms, 30 ms, 40 ms, 50 ms, etc.). As an example, the slot 202 indexed S6 may include one of the CG resources (shown as CG resource 360). Accordingly, the UE 115 may transmit a CG transmission 350 in the CG resource 360 without receiving a specific scheduling grant from the BS 105. The CG transmission 350 may include CG-UCI 352 and UL data 354 (e.g., information data or user data). The UL data 354 may be carried in a PUSCH. The CG-UCI 352 may also be transmitted in the PUSCH, for example, multiplexed with the UL data 354. The UE 115 may also apply HARQ techniques for the transmission of the UL data 354. Thus, the CG-UCI 352 may indicate HARQ information, such as a HARQ process ID, a NDI, and/or RV, associated with the UL data 354. The CG transmission 350 may be referred to as a CG-PUSCH transmission.

The CG transmission 350 may also include a demodulation reference signal (DMRS). The DMRS may include pilot symbols distributed across the frequency channel to enable the UE or the BS to perform channel estimation and demodulation for the decoding. The pilot symbols may be generated from a predetermined sequence with a certain pattern, and the remaining symbols may carry UL data. The DMRS allows a receiver (e.g., the BS 105) to determine a channel estimate for the channel, where the channel estimate may be used to recover the UL data.

In some aspects, the BS 105 may communicate with the UE 115 over a shared radio frequency band (e.g., in a shared spectrum or an unlicensed spectrum). To avoid collisions when communicating in a shared or an unlicensed spectrum, the UE 115 may perform LBT to contend for a COT in the shared channel. In an example, if channel is available (performance of the LBT results in a LBT pass and the UE 115 won the COT), the UE 115 may transmit an UL transmission (e.g., the CG transmission 350) during the COT. In some instances, the CG transmission 350 may occupy a portion of the COT, and the UE 115 may share the remaining time of the COT with the BS 105. To indicate that the BS 105 may share a remaining time in the COT for UL and/or DL transmissions, the UE 115 may include COT sharing information (e.g., a remaining duration in the COT) in the CG-UCI 352. If the channel is not available (performance of the LBT results in a LBT fail), the UE 115 may back off and perform the LBT procedure again at a later point in time.

As can be seen in FIG. 3, the HARQ-ACK information 330 and the UCI 340 that are scheduled for transmission in the slot 202 indexed S6 overlaps with the CG resource 360 configured for the CG transmission 350 including the CG-UCI 352 and the UL data 354. As an example, the CG resource 360 may occupy symbols 2-5 in the slot 202 indexed 6, and the scheduled the HARQ-ACK information 330 may be scheduled in a PUCCH resource 370 occupy symbols 3 of the slot 202 indexed S6 as shown by the reference numeral 302. In general, the scheduled resources for the HARQ-ACK information 330 and the UCI 340 may be at least partially overlapping with the CG resource 360. In some aspects, the UE 115 may be allowed to multiplex up to three separately encoded UCI in a PUSCH transmission, for example, as described in 3GPP Release 15. For instance, the UE 115 may separately encode the HARQ-ACK information 330, the UCI 340, and the CG-UCI 352. Each encoding may include segmentation, cyclic redundancy check (CRC) attachment, polar encoding, rate-match, and/or code block concatenation. Thus, the HARQ-ACK information 330, the UCI 340, and the CG-UCI 352 may be encoded into three separate code blocks. The UE 115 may multiplex the HARQ-ACK information 330, the UCI 340, and the CG-UCI 352 by mapping each code block to the CG resource 360. In some aspects, the UE 115 may map the CG-UCI 352 to a symbol (e.g., the symbol 206) after a DMRS symbol in the CG resource 360. The UE 115 may be configured with a set of rules or a resource mapping order for mapping other scheduled UCI onto the CG resource 360. In some aspects, the UE 115 may determine a number of REs for carrying the UCI 340 using similar mechanisms as for determining a number of REs for carrying the HARQ-ACK information 330. For instance, the BS 105 may configure the UE 115 with a beta offset, which is a variable that controls the coding rate used for sending bits (e.g., coded bits), for sending HARQ-ACK information 330 and another beta offset for sending the CG-UCI 352.

As discussed, the UCI 340 may include CSI part 1 and CSI part 2, and thus there are four UCI parts (e.g., CSI part 1, CSI part 2, HARQ-ACK information 330, and the CG-UCI 352) to be multiplexed, exceeding the maximum number of UCI parts of 3 allowed by the multiplexing rule discussed above. In some aspects, the BS 105 may provide the UE 115 with an RRC configuration indicating whether the UE 115 may multiplex CG-UCI and HARQ-ACK. When the UE 115 is configured for such multiplexing and a PUCCH (e.g., for carrying HARQ-ACK) overlaps with a CG-PUSCH(s) within a PUCCH group (e.g., for CSI part 1, CSI part 2), the UE 115 may jointly encode the HARQ-ACK and CG-UCI. The jointly-encoded HARQ-ACK and CG-UCI may be treated as the same as a code block of HARQ-ACK type. In this regard, the UE 115 may apply the same HARQ-ACK rate matching rule to send the jointly-encoded HARQ-ACK and CG-UCI. Accordingly, the UE 115 may multiplex three encoded UCI parts, encoded CSI part 1, encoded CSI part 2, and the jointly-encoded HARQ-ACK and CG-UCI in the CG transmission 350. When the UE 115 is not configured to multiplex HARQ-ACK with CG-UCI and the a PUCCH (e.g., for carrying HARQ-ACK) overlaps with a CG-PUSCH(s) within a PUCCH group, the UE 115 may skip or drop the CG transmission 350. For instance, the UE 115 may refrain from queuing the CG transmission 350 in a transmission buffer queue or removing the CG transmission 350 from the transmission queue.

In some aspects, the BS 105 may assign a two-level priority for an UL channel or UL transmission, for example, for URLLC. In other words, the BS 105 may assign an UL channel or UL transmission with a high traffic priority or a low traffic priority. In some aspects, the BS 105 may assign a low priority for periodic-CSI (P-CSI), semi-persistent-CSI (SP-CSI), periodic-sounding reference signal (P-SRS), and/or semi-persistent-SRS (SP-SRS). The BS 105 may assign a high priority or a low priority for a dynamically scheduled HARQ-PUCCH via DCI signaling. The BS 105 may assign a high priority or a low priority for a SPS PDSCH via an RRC configuration. The BS 105 may assign a high priority or a low priority for a CG-PUSCH via an RRC configuration.

In some aspects, the HARQ-ACK information 330, the UCI 340, and the CG-UCI 352 may be of different priorities. For instance, the UCI 340 may include CSI part 1 and/or CSI part 2, and thus may be associated with a low priority. The BS 105 may assign a high priority for the HARQ-ACK information 330. The BS 105 may assign a low priority for the CG resource 360, and thus the CG-UCI 352 may be of a low priority. As such, there is an overlap between UCI and CG-UCI of different priorities in the slot 202 indexed S6. However, the multiplexing rules discussed above does not handle multiplexing UCI and CG-UCI of different priorities in a CG-PUSCH transmission.

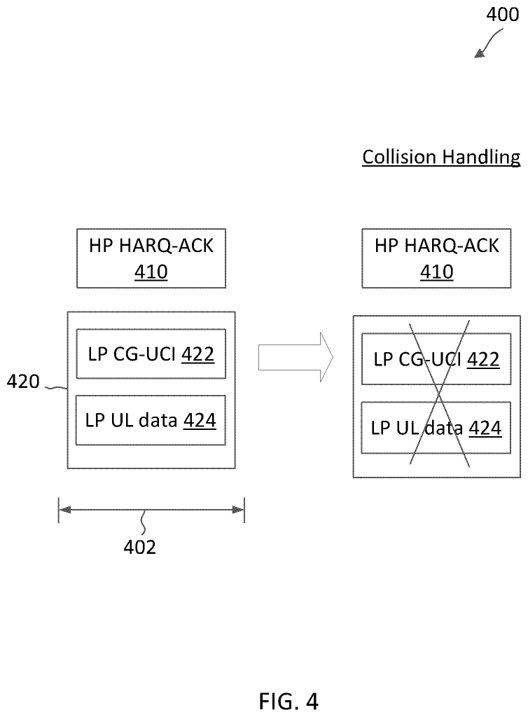

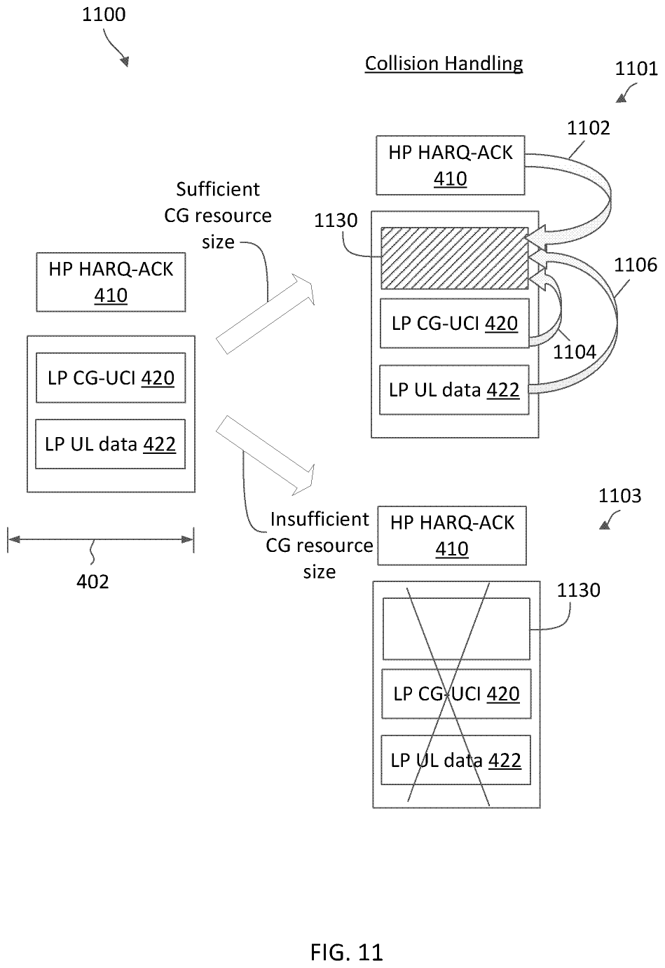

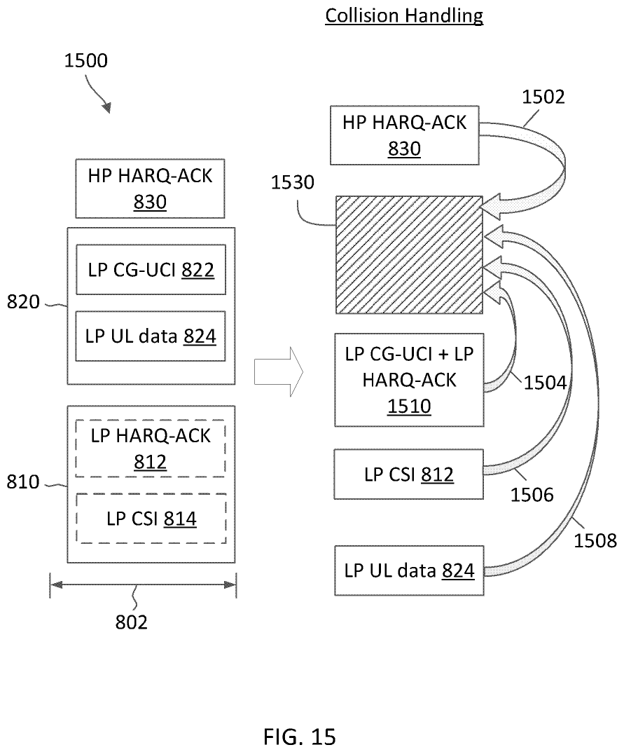

Accordingly, the present disclosure provides techniques for multiplexing UCI and CG-UCI of different priorities in a CG-PUSCH transmission. In an aspect, a UE may multiplex scheduled UCIs, CG-UCIs, and CG UL data of the same traffic priorities according to some multiplexing priority rule or resource mapping rules, and may drop the low-priority transmission and transmit the high-priority transmission as will be discussed below more fully in relation to FIGS. 4-10. In another aspect, a UE may first multiplex scheduled UCIs, CG-UCIs, and CG UL data of the same traffic priorities according to some multiplexing rule or resource mapping rules, followed by multiplexing the across the high-priority multiplexed transmission and the low-priority multiplexed transmission as will be discussed below more fully in relation to FIGS. 11-14. In yet another aspect, a UE may multiplex scheduled UCIs, CG-UCIs, and CG UL data of different traffic priorities according to a multiplexing priority order that is decoupled from the traffic priorities as will be discussed below more fully in relation to FIGS. 15-17. In FIGS. 4-17, the left side illustrates transmissions that are at least partially overlapping or colliding with each other in a time period, and the right side illustrates handling of the overlap or collision by dropping a low-priority transmission and/or multiplexing transmissions of different priorities. The various multiplexing mechanisms can allow a UE to resolve collision between UCI and CG-UCI of different traffic priorities, and thus may improve transmission reliability and/or transmission latency, for example, in URLLC over NR-U. The multiplexing mechanisms may be applicable for transmissions over a licensed band or an unlicensed band.

FIGS. 4-10 illustrate various mechanisms for handling collisions among UCI and CG-UCI of different priorities by dropping a low-priority transmission. FIG. 4 illustrates an uplink transmission scheme 400 for transmissions of different priorities according to one or more aspects of the present disclosure. The scheme 400 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 400.

In some aspects, the UE 115 may determine that a first resource for an uplink transmission associated with a first priority at least partially overlaps with a second resource for a CG-PUSCH transmission associated with a second priority different from the first priority. For instance, the uplink transmission may include HARQ-ACK information scheduled to be transmitted in the first resource (e.g., a PUCCH resource), and the CG-PUSCH transmission may include CG-UCI and UL data to be transmitted in the second resource (e.g., the CG resource 360) similar to the CG transmission 350 discussed above in relation to FIG. 3. The first priority may be higher than the second priority. In other words, the HARQ-ACK information may have a higher traffic priority than the CG-PUSCH transmission. In the scheme 400, the UE 115 resolves the overlap or collision by dropping the low-priority CG-PUSCH transmission and transmitting the high-priority HARQ-ACK information.

In the illustrated example of FIG. 4, the UE 115 is scheduled to transmit high-priority (HP) HARQ-ACK information 410 in a time period 402 (e.g., the slot 202) overlapping with a low-priority (LP) CG-PUSCH transmission 420. For instance, the BS 105 may transmit a scheduling grant to the UE 115, for example, via DCI (e.g., DCI 310 and 320). The scheduling grant may indicate a PUCCH resource within the time period 402 for the HP HARQ-ACK information 410. The BS 105 may also configure the UE 115 with a configured grant indicating a CG resource within the time period 402 for the LP CG-PUSCH transmission 420, for example, via an RRC configuration. The HP HARQ-ACK information 410 may be similar to the HARQ-ACK information 330. The HP HARQ-ACK information 410 may be a feedback for a PDSCH transmission of a high traffic priority. The CG-PUSCH transmission 420 may include LP CG-UCI 422 and LP UL data 424 (e.g., LP data traffic). The LP CG-UCI 422 may provide information (e.g., HARQ process ID, NDI, RV) associated with the LP UL data 424 and/or COT sharing information.

To handle the overlap or collision, the UE 115 may determine that the HARQ-ACK information 410 has a higher priority than the CG-PUSCH transmission 420, and proceed to transmit the HP HARQ-ACK information 410 in the PUCCH resource and refrain from transmitting the CG-PUSCH transmission 420 (shown by the cross symbol “X”) in the CG resource.

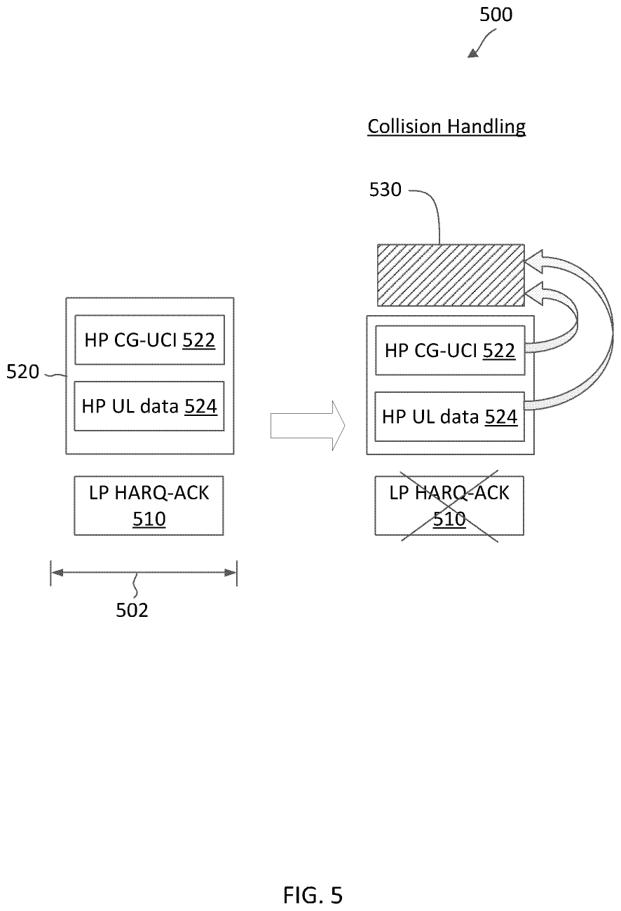

FIG. 5 illustrates an uplink transmission scheme 500 for transmissions of different priorities according to one or more aspects of the present disclosure. The scheme 500 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 500.

In some aspects, the UE 115 may determine that a first resource for an uplink transmission associated with a first priority at least partially overlaps with a second resource for a CG-PUSCH transmission associated with a second priority different from the first priority. For instance, the uplink transmission may include HARQ-ACK information scheduled to be transmitted in the first resource (e.g., a PUCCH resource), and the CG-PUSCH transmission may include CG-UCI and UL data to be transmitted in the second resource (e.g., the CG resource 360) similar to the CG transmission 350 discussed above in relation to FIG. 3. The first priority may be lower than the second priority. In other words, the HARQ-ACK information may have a lower traffic priority than the CG-PUSCH transmission. In the scheme 500, the UE 115 resolves the overlap or collision by dropping the low-priority HARQ-ACK information and transmitting the high-priority CG-PUSCH transmission.

In the illustrated example of FIG. 5, the UE 115 is scheduled to transmit LP HARQ-ACK information 510 in a time period 502 (e.g., the slot 202) overlapping with a HP CG-PUSCH transmission 520. For instance, the BS 105 may transmit a scheduling grant to the UE 115, for example, via DCI (e.g., DCI 310 and 320). The scheduling grant may indicate a PUCCH resource within the time period 502 for the LP HARQ-ACK information 510. The BS 105 may also configure the UE 115 with a configured grant indicating a CG resource within the time period 502 for the HP CG-PUSCH transmission 520, for example, via an RRC configuration. The LP HARQ-ACK information 510 may be similar to the HARQ-ACK information 330 and/or 410. The LP HARQ-ACK information 510 may be a feedback for a PDSCH transmission of a low traffic priority. The CG-PUSCH transmission 520 may include HP CG-UCI 522 and HP UL data 524 (e.g., HP data traffic). The HP CG-UCI 522 may provide information (e.g., HARQ process ID, NDI, RV) associated with the HP UL data 524 and/or COT sharing information.

To handle the overlap or collision, the UE 115 may determine that the HARQ-ACK information 510 has a lower priority than the CG-PUSCH transmission 520, and proceed to transmit the HP CG transmission 520 in the CG resource and refrain from transmitting the LP HARQ-ACK information (shown by the cross symbol “X”) in the PUCCH resource. The CG resource is shown by 530. The CG resource 530 may include a plurality of REs (e.g., REs 212) in a number of symbols (e.g., symbols 206) in time and a number of subcarriers (e.g., subcarriers 204) in frequency. The UE 115 may multiplex the HP CG UCI 522 with the HP UL data 524 in the CG resource 530 as shown by the curved arrows. In some aspects, the UE 115 may map the HP CG UCI 522 to resources (e.g., REs 212) in the CG resource 530, followed by mapping the HP UL data 524 to resources in the CG resource 530.

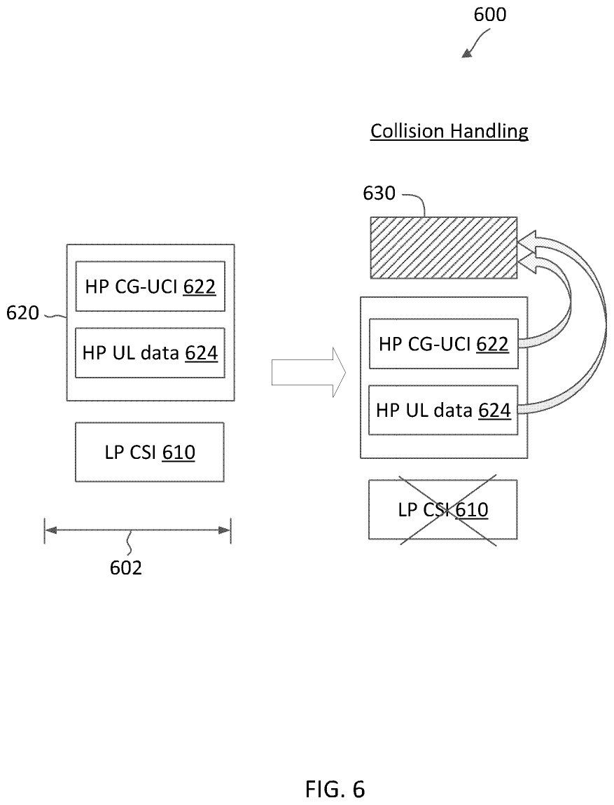

FIG. 6 illustrates a communication scheme for handling collision between CG-UCI and scheduled UCI of different priorities according to one or more aspects of the present disclosure. The scheme 600 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 600.

In some aspects, the UE 115 may determine that a first resource for an uplink transmission associated with a first priority at least partially overlaps with a second resource for a CG-PUSCH transmission associated with a second priority different from the first priority. For instance, the uplink transmission may include CSI scheduled to be transmitted in the first resource (e.g., a PUCCH resource), and the CG-PUSCH transmission may include CG-UCI and UL data to be transmitted in the second resource (e.g., the CG resource 360) similar to the CG transmission 350 discussed above in relation to FIG. 3. The first priority may be lower than the second priority. In other words, the CSI may have a lower traffic priority than the CG-PUSCH transmission. In the scheme 500, the UE 115 resolves the overlap or collision by dropping the low-priority CSI and transmitting the high-priority CG-PUSCH transmission. In some aspects, CSI may be assigned with a low traffic priority the communication between the BS 105 and the UE 115 may not be impacted by the UE 115 missing one CSI report transmission.

In the illustrated example of FIG. 6, the UE 115 is scheduled to transmit LP CSI 610 within a time period 602 (e.g., the slot 202) overlapping with a HP CG-PUSCH transmission 620. For instance, the BS 105 may configure the UE 115 with a PUCCH resource within the time period 602 for the LP CSI 610. The BS 105 may also configure the UE 115 with a configured grant indicating a CG resource within the time period 602 for the HP CG-PUSCH transmission 620, for example, via an RRC configuration. The LP CSI 610 may include CSI part 1 and/or CSI part 2, where the CSI part 1 may include RI, CRI, and/or CQI, and the CSI part 2 may include PMI and/or subband differential CQI as discussed above. The CG-PUSCH transmission 620 may include HP CG-UCI 622 and HP UL data 624 (e.g., HP data traffic). The HP CG-UCI 622 may provide information (e.g., HARQ process ID, NDI, RV) associated with the HP UL data 624 and/or COT sharing information.

To handle the overlap or collision, the UE 115 may determine that the CSI 610 has a lower priority than the CG-PUSCH transmission, and proceed to transmit the HP CG-PUSCH transmission 620 in the CG resource and refrain from transmitting the LP CSI 610 (as shown by the cross symbol “X”) in the PUCCH resource. The CG resource is shown by 630. The CG resource 630 may include a plurality of REs (e.g., REs 212) in a number of symbols (e.g., symbols 206) in time and a number of subcarriers (e.g., subcarriers 204) in frequency. The UE 115 may multiplex the HP CG UCI 622 with the HP UL data 624 in the CG resource 630 as show by the curved arrows. In some aspects, the UE 115 may map the HP CG UCI 622 to resources (e.g., REs 212) in the CG resource 630, followed by mapping the HP UL data 624 to resources in the CG resource 630.

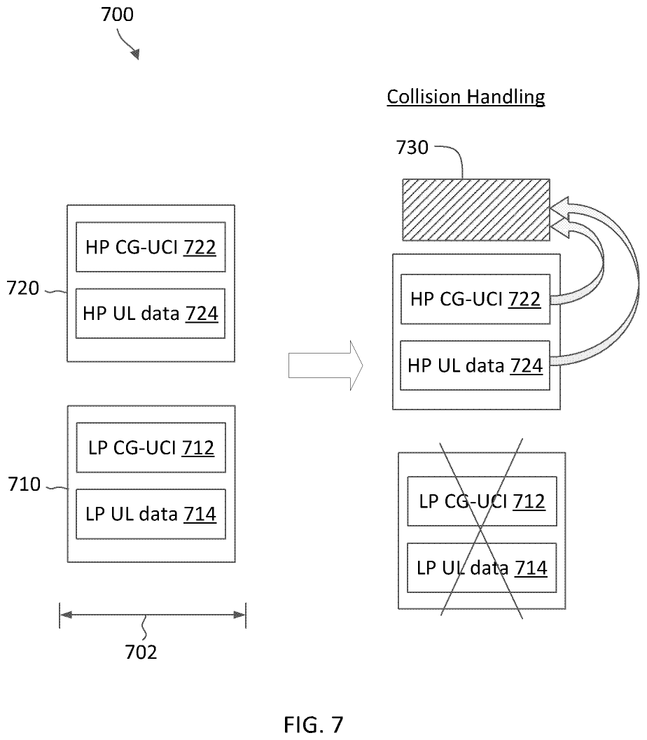

FIG. 7 illustrates a communication scheme for handling collision between CG-UCI and scheduled UCI of different priorities according to one or more aspects of the present disclosure. The scheme 700 may be employed by BSs such as the BSs 105 and UEs such as the UEs 115 in a network such as the network 100 for UL communications. In particular, a UE 115 may handle an overlap or collision between CG-UCIs of different priorities as shown in the scheme 700.

In some aspects, the UE 115 may determine that a first resource for an uplink transmission associated with a first priority at least partially overlaps with a second resource for a CG-PUSCH transmission associated with a second priority different from the first priority. For instance, the uplink transmission may include another CG-PUSCH transmission to be transmitted in the first resource. Each of the CG-PUSCH transmissions may include CG-UCI and UL data to be transmitted in the second resource. The first and second resources are CG resources (e.g., the CG resource 360) of different priorities (e.g., a low priority and a high priority). In the scheme 500, the UE 115 resolves the overlap or collision by dropping the low-priority CG-PUSCH transmission and transmits the high-priority CG-PUSCH transmission.

In the illustrated example of FIG. 7, the UE 115 is configured to transmit a LP CG-PUSCH transmission 710 including LP CG-UCI 712 and LP UL data 714 in a first CG resource within a time period 702 (e.g., the slot 202) overlapping with a second CG resource configured for a HP CG-PUSCH transmission 720 including HP CG-UCI 722 and HP UL data 724. For instance, the BS 105 may configure the UE 115 with a first configured grant for the first CG resource (e.g., assigned with a low priority) and a second configured grant for the second CG resources (e.g., assigned with a high priority) from the BS 105 via RRC configurations. The LP CG-UCI 712 may provide information (e.g., HARQ process ID, NDI, RV) associated with the HP UL data 724 and/or COT sharing information. Similarly, the HP CG-UCI 722 may provide information (e.g., HARQ process ID, NDI, RV) associated with the HP UL data 724 and/or COT sharing information.

To handle the overlap or collision, the UE 115 may determine that HP CG-PUSCH transmission 720 has a higher priority than the LP CG-PUSCH transmission 710, and proceed to transmit the HP CG-PUSCH transmission in the second CG resource and drop the LP CG-PUSCH transmission in the first CG resource (shown by the cross symbol “X”). The second HP CG resource is shown by 730. The CG resource 730 may include a plurality of REs (e.g., REs 212) in a number of symbols (e.g., symbols 206) in time and a number of subcarriers (e.g., subcarriers 204) in frequency. The UE 115 may multiplex the HP CG UCI 722 with the HP UL data 724 in the CG resource 730 as show by the curved arrows. In some aspects, the UE 115 may map the HP CG UCI 722 to resources (e.g., REs 212) in the CG resource 730, followed by mapping the HP UL data 724 to resources in the CG resource 730.

In some other aspects, when the UE 115 determines a HP CG resource overlapping with a LP CG resource, the UE 115 may determine whether to transmit a LP CG-PUSCH transmission in the LP CG resource or a HP CG-PUSCH transmission in the HP CG resource based on whether the LP CG-PUSCH transmission or the HP CG-PUSCH transmission includes UL data (e.g., UL-SCH data) or not. For instance, if only one of the HP CG-PUSCH transmission or the LP CG-PUSCH transmission carries UL data, the UE 115 may transmit the CG-PUSCH transmission that carries UL data and refrain from transmitting the other CG-PUSCH transmission that does not include any UL data. In other words, if the HP CG-PUSCH transmission includes UL data and the LP CG-PUSCH transmission does not include UL data, the UE 115 may transmit the HP CG-PUSCH transmission or vice versa. However, if both the HP CG-PUSCH and the LP CG-PUSCH transmission include UL data, the UE 115 may select which CG-PUSCH transmission to transmit, and the BS 105 may perform blind decoding to determine whether the UE 115 transmitted the HP CG-PUSCH transmission or the LP CG-PUSCH transmission.

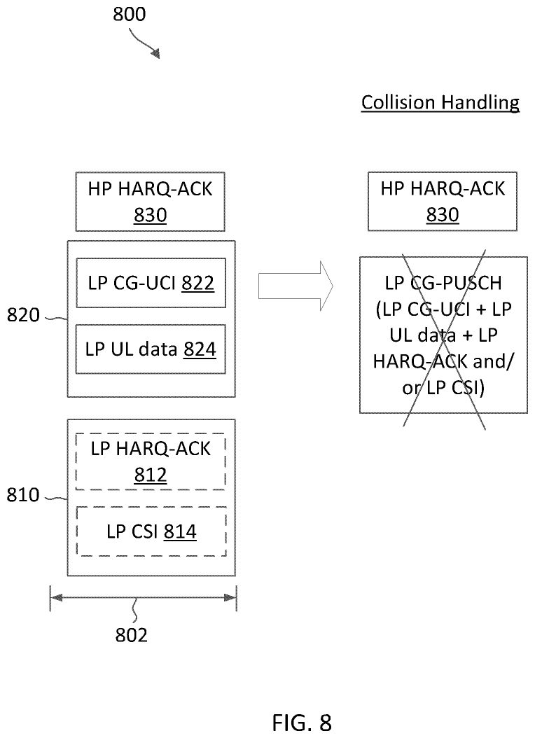

FIG. 8 illustrates a communication scheme for handling collision between CG-UCI and scheduled UCI of different priorities according to one or more aspects of the present disclosure. The scheme 800 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 800.

In some aspects, the UE 115 may determine that a first uplink transmission associated with a first priority and a second uplink transmission associated with a second priority are in a time period that at least partially overlaps with a first resource for a CG-PUSCH transmission associated with the first priority. The first priority may be lower than the second priority. The first uplink transmission may include LP HARQ-ACK information and/or CSI (which may be of a low priority). The second uplink transmission may include HP HARQ-ACK information. The CG-PUSCH transmission may be a LP CG-PUSCH transmission including CG-UCI and UL data. In the scheme 800, the UE 115 may first resolve collision among transmissions of the same priority and then drop a lower priority transmission. For instance, the UE 115 may first multiplex the LP HARQ-ACK and/or the CSI with CG-UCI and UL data (of the low priority) into the LP CG-PUSCH transmission. The UE 115 may transmit the HP HARQ-ACK information and drop the LP CG-PUSCH transmission including the LP HARQ-ACK and/or the CSI multiplexed with the CG-UCI and UL data.

In the illustrated example of FIG. 8, the UE 115 is scheduled to transmit LP UCI 810 and HP HARQ-ACK information 830 in a time period 802 (e.g., the slot 202) overlapping with a LP CG-PUSCH transmission 820. In some instances, the LP UCI 810 may include LP HARQ-ACK information 812. In some other instances, the LP UCI 810 may include LP CSI 814. In yet some other instances, the LP UCI 810 may include LP HARQ-ACK information 812 and the LP CSI 814. For instance, the BS 105 may transmit scheduling grant(s) to the UE 115, for example, via DCI (e.g., DCI 310 and 320). The scheduling grant(s) may indicate PUCCH resource(s) within the time period 802 for the LP HARQ-ACK information 812 and the HP HARQ-ACK information 830. In some instances, each of the LP HARQ-ACK information 812 and HP HARQ-ACK information 830 may be scheduled by a different scheduling grant. In some other instances, the LP HARQ-ACK information 812 may be scheduled by one grant and HP HARQ-ACK information 830 may be scheduled by another grant. The BS may configure the UE 115 with a PUCCH resource within the time period 802 for the LP CSI 814, for example, via RRC configuration. The BS 105 may also configure the UE 115 with a configured grant indicating a CG resource within the time period 802 for the LP CG-PUSCH transmission 820, for example, via an RRC configuration. The LP HARQ-ACK information 812 may be similar to the HARQ-ACK information 330. The LP HARQ-ACK information 812 may be a feedback for a PDSCH transmission of a low traffic priority. The LP CSI 814 may include CSI part 1 and/or CSI part 2, where the CSI part 1 may include RI, CRI, and/or CQI, and the CSI part 2 may include PMI and/or subband differential CQI as discussed above. The CG-PUSCH transmission 820 may include LP CG-UCI 822 and LP UL data 824 (e.g., LP data traffic). The LP CG-UCI 822 may provide information (e.g., HARQ process ID, NDI, RV) associated with the LP UL data 824 and/or COT sharing information.

To handle the overlap or collision, the UE 115 may determine that the LP CG-PUSCH transmission 820 has the same priority as the at least one of the LP HARQ-ACK information 812 or the LP CSI 814, and proceed to multiplex the at least one of the LP HARQ-ACK information 812 or the LP CSI 814 with the LP CG-UCI 822 and the LP UL data 824 in the CG-PUSCH transmission 820 according to certain resource mapping rules or multiplexing rules. In some aspects, the UE 115 may perform the multiplex by mapping the LP CG UCI 822, the LP HARQ-ACK information 812, the LP CSI 814, and the LP UL data 824 to resources (e.g., REs 212) in the CG resource in order. In some aspects, the UE 115 may separately encode the LP HARQ-ACK information 812 and LP CG-UCI 822 into a first code block (coded bits), encode the CSI part 1 of LP CSI 814 into a second code block, and encode the CSI part 2 of LP CSI 814 into a third code block, and the multiplexing may include multiplexing the first, second, and third code blocks with coded LP UL data 824 into a multiplexed transmission.

After the multiplexing, the UE 115 may determine that that the HP HARQ-ACK information 830 has a higher priority than the LP CG-PUSCH transmission 820 (including the at least one of the LP HARQ-ACK information 812 or the LP CSI 814 multiplexed with the LP CG-UCI 822 and the LP UL data 824), and proceed to transmit the HP HARQ-ACK information 830 in a PUCCH resource (within the time period 802) scheduled for the HP HARQ-ACK information 830 and refrain from transmitting the multiplexed LP CG-PUSCH transmission (shown by the cross symbol “X”).

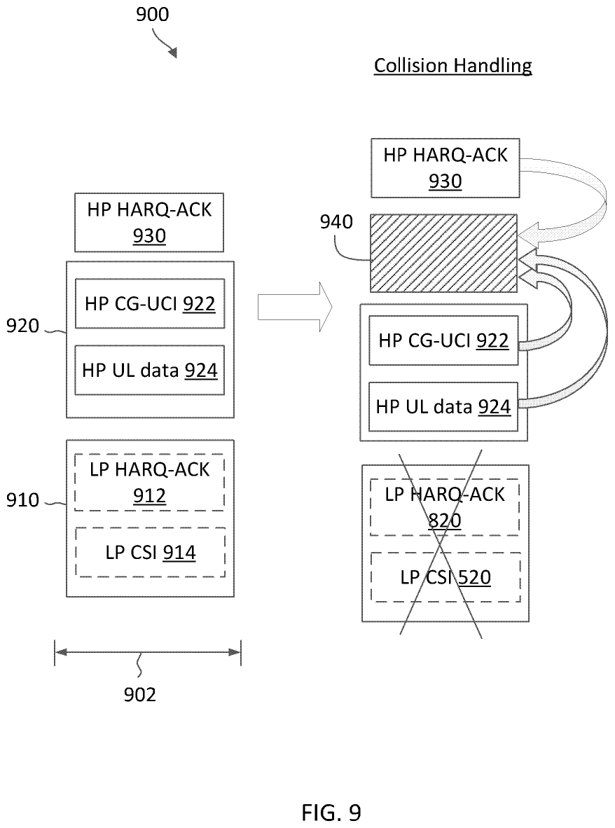

FIG. 9 illustrates a communication scheme for handling collision between CG-UCI and scheduled UCI of different priorities according to one or more aspects of the present disclosure. The scheme 900 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 900.

In some aspects, the UE 115 may determine that a first uplink transmission associated with a first priority and a second uplink transmission associated with a second priority are in a time period that at least partially overlaps with a first resource for a CG-PUSCH transmission associated with the first priority. The first priority may be higher than the second priority. The first uplink transmission may include HP HARQ-ACK information. The second uplink transmission may include LP HARQ-ACK information and/or LP CSI. The CG-PUSCH transmission may be a HP CG-PUSCH transmission including CG-UCI and UL data. In the scheme 900, the UE 115 may first resolve collision among transmissions of the same priority and then drop a lower priority transmission. For instance, the UE 115 may multiplex the HP HARQ-ACK with CG-UCI and UL data (of the high priority) into the HP CG-PUSCH transmission. The UE 115 may drop the LP HARQ-ACK information and LP CSI and transmit the HP CG-PUSCH transmission including the HP HARQ-ACK multiplexed with the CG-UCI and UL data.

In the illustrated example of FIG. 9, the UE 115 is scheduled to transmit LP UCI 910 and HP HARQ-ACK information 930 in a time period 902 (e.g., the slot 202) overlapping with a HP CG-PUSCH transmission 920. In some instances, the LP UCI 910 may include LP HARQ-ACK information 912. In some other instances, the LP UCI 910 may include LP CSI 914. In yet some other instances, the LP UCI 910 may include LP HARQ-ACK information 912 and the LP CSI 914. For instance, the BS 105 may transmit scheduling grant(s) to the UE 115, for example, via DCI (e.g., DCI 310 and 320). The scheduling grant(s) may indicate PUCCH resource(s) within the time period 902 for the LP HARQ-ACK information 912 and the HP HARQ-ACK information 930. In some instances, each of the LP HARQ-ACK information 912, and HP HARQ-ACK information 930 may be scheduled by a different scheduling grant. In some other instances, the LP HARQ-ACK information 912 may be scheduled by one grant and HP HARQ-ACK information 930 may be scheduled by another grant. The BS 105 may configure the UE 115 with a PUCCH resource within the time period 902 for the LP CSI 914, for example, via RRC configuration. The BS 105 may also configure the UE 115 with a configured grant indicating a CG resource within the time period 902 for the HP CG-PUSCH transmission 920, for example, via an RRC configuration. The CG-PUSCH transmission 920 may include HP CG-UCI 922 and HP UL data 924 (e.g., HP data traffic). The HP CG-UCI 922 may provide information (e.g., HARQ process ID, NDI, RV) associated with the HP UL data 924 and/or COT sharing information.

To handle the overlap or collision, the UE 115 may determine that the HP CG-PUSCH transmission 920 has the same priority as the HP HARQ-ACK information 930, and proceed to multiplex the HP HARQ-ACK information 930 with the HP CG-UCI 922 and the HP UL data 924 in the CG-PUSCH transmission 920 according to certain resource mapping rules or multiplexing rules. The CG resource is shown by 940. The CG resource 940 may include a plurality of REs (e.g., REs 212) in a number of symbols (e.g., symbols 206) in time and a number of subcarriers (e.g., subcarriers 204) in frequency. In some aspects, the UE 115 may perform the multiplex by mapping the HP CG UCI 922, the HP UL data 924, and the HP HARQ-ACK information 930 to resources (e.g., REs 212) in the CG resource 940 in order as shown by curved arrows. In some aspects, the UE 115 may jointly encode the HP HARQ-ACK information 930 and the HP CG-UCI 922 into a first code block (coded bits), and the multiplexing may include multiplexing the first code block with coded HP UL data 924 into a multiplexed HP CG-PUSCH transmission.

After the multiplexing, the UE 115 may determine that that the multiplexed HP CG-PUSCH transmission 920 (including the HP HARQ-ACK information 930 multiplexed with the HP CG-UCI 922 and the HP UL data 924) has a higher priority than the LP HARQ-ACK information 912 and/or LP CSI 914, and proceed to transmit the multiplexed HP CG-PUSCH transmission 920 in the CG resource 940 and refrain from transmitting the LP HARQ-ACK information 912 and/or LP CSI 914 in PUCCH resource(s) (within the time period 902) scheduled for the LP HARQ-ACK information 912 and/or LP CSI 914 (shown by the cross symbol “X”).

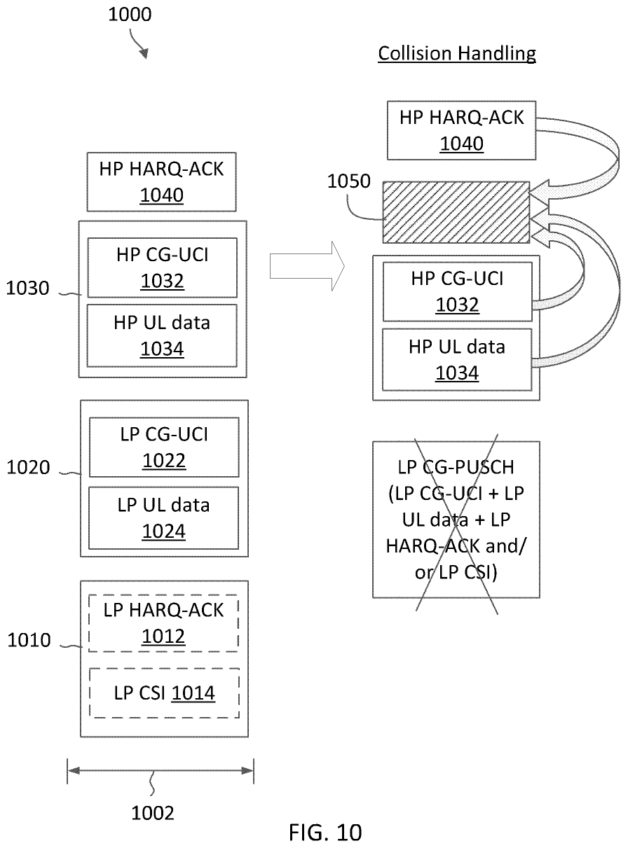

FIG. 10 illustrates an uplink transmission scheme 1000 for transmissions of different priorities according to one or more aspects of the present disclosure. The scheme 1000 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1000.

In some aspects, the UE 115 may determine that a first uplink transmission associated with a first priority and a second uplink transmission associated with a second priority are in a time period that at least partially overlaps with a first resource for a first CG-PUSCH transmission associated with the first priority. The first priority may be higher than the second priority. The first uplink transmission may include HP HARQ-ACK information. The second uplink transmission may include a LP CG-PUSCH transmission and LP HARQ-ACK information and/or LP CSI. The first CG-PUSCH transmission may be a HP CG-PUSCH transmission including HP CG-UCI and HP UL data. The LP CG-PUSCH transmission may include LP CG-UCI and LP UL data. In the scheme 1000, the UE 115 may first resolve collision among transmissions of the same priority and then drop a lower priority transmission. For instance, the UE 115 may multiplex the HP HARQ-ACK with the HP CG-UCI and HP UL data in the HP CG-PUSCH transmission. The UE 115 may further multiplex the LP HARQ-ACK and/or LP CSI with the LP CG-UCI and LP UL data in the LP CG-PUSCH transmission. The UE 115 may drop the multiplexed LP CG-PUSCH transmission (including the LP HARQ-ACK and/or LP CSI multiplexed with the CG-UCI and UL data) and transmit the multiplexed HP CG-PUSCH transmission (including the HP HARQ-ACK multiplexed with the HP CG-UCI and HP UL data).

In the illustrated example of FIG. 10, the UE 115 is scheduled to transmit LP UCI 1010 and HP HARQ-ACK information 1040 in a time period 1002 (e.g., the slot 202) overlapping with a LP CG-PUSCH transmission 1020 and a HP CG-PUSCH transmission 1030. In some instances, the LP UCI 1010 may include LP HARQ-ACK information 1012. In some other instances, the LP UCI 1010 may include LP CSI 1014. In yet some other instances, the LP UCI 1010 may include LP HARQ-ACK information 1012 and the LP CSI 1014. For instance, the BS 105 may transmit scheduling grant(s) to the UE 115, for example, via DCI (e.g., DCI 310 and 320). The scheduling grant(s) may indicate PUCCH resource(s) within the time period 1002 for the LP HARQ-ACK information 1012 and the HP HARQ-ACK information 1040. In some instances, each of the LP HARQ-ACK information 1012, and HP HARQ-ACK information 1040 may be scheduled by a different scheduling grant. In some other instances, the LP HARQ-ACK information 1012 may be scheduled by one grant and HP HARQ-ACK information 1040 may be scheduled by another grant. The BS 105 may configure the UE 115 with a PUCCH resource for LP CSI 1014, for example, via RRC configuration. The BS 105 may also configure the UE 115 with a configured grant indicating a LP CG resource within the time period 1002 for the LP CG-PUSCH transmission 1020 and configured grant indicating a HP CG resource within the time period 1002 for the HP CG-PUSCH transmission 1030, for example, via an RRC configuration. The LP CG-PUSCH transmission 1020 may include LP CG-UCI 1022 and LP UL data 1024 (e.g., LP data traffic). The LP CG-UCI 1022 may provide information (e.g., HARQ process ID, NDI, RV) associated with the LP UL data 1024 and/or COT sharing information. Similarly, the HP CG-PUSCH transmission 1030 may include HP CG-UCI 1032 and HP UL data 1034 (e.g., HP data traffic). The HP CG-UCI 1032 may provide information (e.g., HARQ process ID, NDI, RV) associated with the HP UL data 1034 and/or COT sharing information.

To handle the overlap or collision, the UE 115 may determine that the HP CG-PUSCH transmission 1030 has the same priority as the HP HARQ-ACK information 1040, and proceed to multiplex the HP HARQ-ACK information 1040 with the HP CG-UCI 1032 and the HP UL data 1034 in the HP CG-PUSCH transmission 1030 according to certain resource mapping rules or multiplexing rules. The HP CG resource is shown by 1050. The CG resource 1050 may include a plurality of REs (e.g., REs 212) in a number of symbols (e.g., symbols 206) in time and a number of subcarriers (e.g., subcarriers 204) in frequency. In some aspects, the UE 115 may perform the multiplex by mapping the HP CG UCI 1032, the HP UL data 1034, and the HP HARQ-ACK information 1040 to resources (e.g., REs 212) in the HP CG resource 1050 in order as shown by the curved arrows. In some aspects, the UE 115 may separately encode the HP HARQ-ACK information 1040 and the HP CG-UCI 1032 into a first code block (coded bits), and the multiplexing may include multiplexing the first code block with coded HP UL data 1034 into a multiplexed HP CG-PUSCH transmission. Similarly, the UE 115 may determine that the LP CG-PUSCH transmission 1020 has the same priority as the LP HARQ-ACK information 1012 and/or LP CSI 1014, and proceed to multiplex the LP HARQ-ACK information 1012 and/or LP CSI 1014 with the LP CG-UCI 1022 and the LP UL data 1024 in the LP CG-PUSCH transmission 1020 according to certain resource mapping rules or multiplexing rules.

After the multiplexing, the UE 115 may determine that that the multiplexed HP CG-PUSCH transmission 1030 has a higher priority than the multiplex LP CG-PUSCH transmission 1020, and proceed to transmit the multiplexed HP CG-PUSCH transmission 1030 and refrain from transmitting the multiplexed LP CG-PUSCH transmission 1020 in the LP CG resource (within the time period 1002) (shown by the cross symbol “X”).

FIGS. 11-14 illustrate various mechanisms for handling collisions among UCI and CG-UCI of different priorities by multiplexing UCI and CG-UCI of the same priority if there are UCI and CG-UCI of the same priority, followed by multiplexing across UCI and CG-UCI of different priorities.

FIG. 11 illustrates an uplink transmission scheme 1100 for transmissions of different priorities according to one or more aspects of the present disclosure. The scheme 1100 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1100. FIG. 11 illustrates the same transmission scenario as in FIG. 4, and may use the same reference numerals as in FIG. 4 for simplicity's sake. However, in the scheme 1100, the UE 115 may handle collisions among UCI and CG-UCI of different priorities by multiplexing UCI and CG-UCI of the same priority if there are UCI and CG-UCI of the same priority, followed by multiplexing across UCI and CG-UCI of different priorities.

For instance, when the UE 115 is scheduled to transmit HP HARQ-ACK information 410 in a time period 402 overlapping with a CG resource for a LP CG-PUSCH transmission 420, the UE 115 generates an UL communication signal by multiplexing the HP HARQ-ACK information 410 with the LP CG-PUSCH transmission 420 according to a certain multiplexing priority order (e.g., in an order of HP HARQ-ACK information, LP CG UCI, and LP UL data). In the illustrated example of FIG. 11, the CG resource is shown as 1130 in the right side of FIG. 11. The CG resource 1130 may include a plurality of REs (e.g., REs 212) in a number of symbols (e.g., symbols 206) in time and a number of subcarriers (e.g., subcarriers 204) in frequency. The UE 115 may generate a multiplexed CG-PUSCH transmission. As shown by 1101, at 1102, the UE 115 the HP HARQ-ACK information 410 to a first set of REs in the CG resource 1130 according to a certain resource mapping rule. At 1104, after mapping the HP HARQ-ACK information 410, the UE 115 maps the LP CG-UCI 422 to one or more of the remaining REs the CG resource 1130 according to the resource mapping rule. At 1106, after mapping the LP CG-UCI 422, the UE 115 maps the LP UL data 424 to one or more of the remaining REs in the CG resource 1130 according to the resource mapping rule. The UE 115 may separately encode the LP CG-UCI 422 into a first code block and the HP HARQ-ACK information 410 into a second code block based on a certain MCS. The mapping may be performed on the coded bits. The mapping may include generating an UL communication signal (a LP CG-PUSCH transmission) including frequency data points corresponding to the mapped information in the order of the mapping. Subsequently, the UE 115 transmits the UL communication signal in the LP CG resource 1130.

In some instances, the CG resource 1130 may not be sufficient (e.g., a sufficient number of REs) in carrying the multiplexed transmission (the HP HARQ-ACK information 410 multiplexed with the LP CG-UCI 422 and LP UL data 424). When the CG resource 1130 is not sufficient, the UE 115 may drop the LP CG-PUSCH transmission. For instance, after 1102, the UE 115 may determine whether a number of remaining REs in the CG resource 1130 satisfies a threshold. The threshold may correspond to a number REs for carrying code bits of the LP CG-UCI 422 and the LP UL data 424 based on a certain modulation coding scheme (MCS). If the number of remaining REs satisfies the threshold, the UE 115 proceed to 1104. If the number of remaining REs fails to satisfy the threshold, the UE 115, the UE 115 may refrain from continuing to map the LP CG-UCI 422 and/or LP CG data 424 to the CG resource 1130. As shown by 1103, the UE 115 may transmit the HP HARQ-ACK information 410 in a PUCCH resource scheduled for the HP HARQ-ACK information 410 within the time period 402 and refrain from transmitting the CG-PUSCH transmission 420 (shown by the cross symbol “X”) in the CG resource.

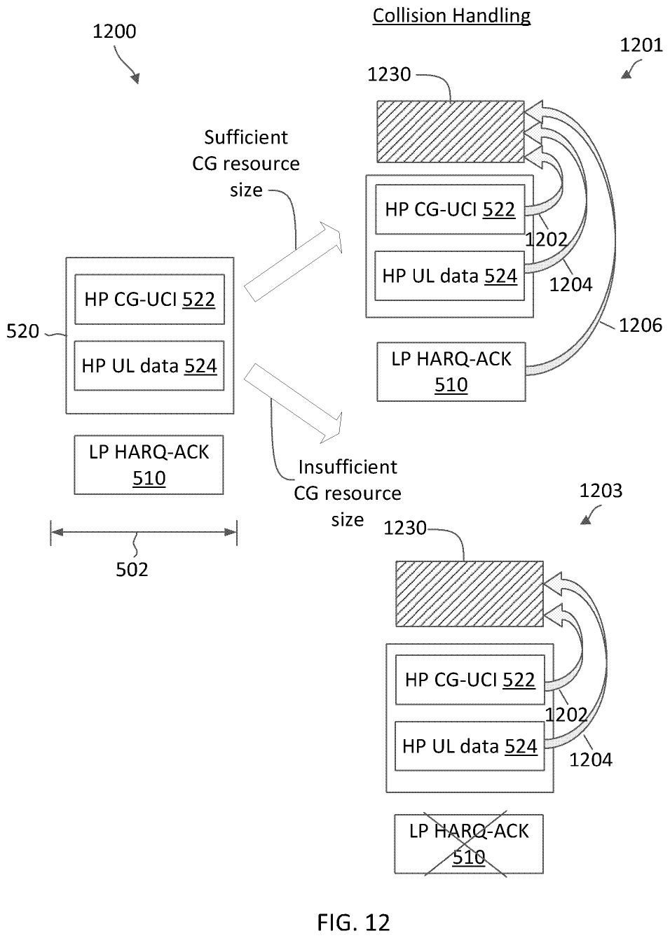

FIG. 12 illustrates an uplink transmission scheme 1200 for transmissions of different priorities according to one or more aspects of the present disclosure. The scheme 1200 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1200. FIG. 12 illustrates the same transmission scenario as in FIG. 5, and may use the same reference numerals as in FIG. 5 for simplicity's sake. However, in the scheme 1200, the UE 115 may handle collisions among UCI and CG-UCI of different priorities by multiplexing UCI and CG-UCI of the same priority if there are UCI and CG-UCI of the same priority, followed by multiplexing across UCI and CG-UCI of different priorities.

For instance, when the UE 115 is scheduled to transmit LP HARQ-ACK information 510 in a time period 502 overlapping with a CG resource for a HP CG-PUSCH transmission 520, the UE 115 generates an UL communication signal by multiplexing the LP HARQ-ACK information 510 with the HP CG-PUSCH transmission 520 according to a certain multiplexing priority order (e.g., in an order of HP CG UCI, HP UL data, LP HARQ-ACK). In the illustrated example of FIG. 12, the CG resource is shown as 1230 in the right side of FIG. 12. The CG resource 1230 may include a plurality of REs (e.g., REs 212) in a number of symbols (e.g., symbols 206) in time and a number of subcarriers (e.g., subcarriers 204) in frequency. The UE 115 may generate a multiplexed CG-PUSCH transmission. As shown by 1201, at 1202, the UE 115 maps the HP CG-UCI 522 to a first set of REs in the CG resource 1230 according to the resource mapping rule. At 1204, after mapping the HP CG-UCI 522, the UE 115 maps the HP UL data 524 to one or more of the remaining REs in the CG resource 1230 according to the resource mapping rule. At 1206, after mapping the HP UL data 524, the UE 115 maps the LP HARQ-ACK information 510 to one or more of the remaining REs in the CG resource 1230 according to the resource mapping rule. The mapping may include generating an UL communication signal (a HP CG-PUSCH transmission) including frequency points corresponding to the mapped information in the order of the mapping as discussed above in relation to FIG. 8. Subsequently, the UE 115 transmits the UL communication signal in the HP CG resource 1230.

In some instances, the CG resource 1230 may not be sufficient (e.g., a sufficient number of REs) in carrying the multiplexed transmission (the HP HARQ-ACK information 410 multiplexed with the HP CG-UCI 522 and HP UL data 524). When the CG resource 1230 is not sufficient, the UE 115 may drop the LP HARQ-ACK information 510. For instance, after 1204, the UE 115 may determine whether a number of remaining REs in the CG resource 1230 satisfies a threshold. The threshold may correspond to a number REs for carrying code bits of the LP HARQ-ACK information 510 based on a certain MCS. If the number of remaining REs satisfies the threshold, the UE 115 proceed to 1206. If the number of remaining REs fails to satisfy the threshold, the UE 115, the UE 115 may refrain from mapping the LP HARQ-ACK information 510 to the CG resource 1230. As shown by 1203, the UE 115 may transmit the HP CG-PUSCH transmission 520 (including the HP HARQ-ACK information 410 multiplexed with the HP CG-UCI 522 and HP UL data 524) in the CG resource 1230 and refrain from transmitting the LP HARQ-ACK information 510 (shown by the cross symbol “X”).

Although FIG. 12 illustrates an overlap between the HP CG-PUSCH transmission 520 and LP HARQ-ACK information 510, it should be understood that similar mechanisms may be applied to an overlap between the HP CG-PUSCH transmission 520 and LP HARQ-ACK information and CSI (e.g., CSI 610) or between the HP CG-PUSCH transmission 520 and CSI.

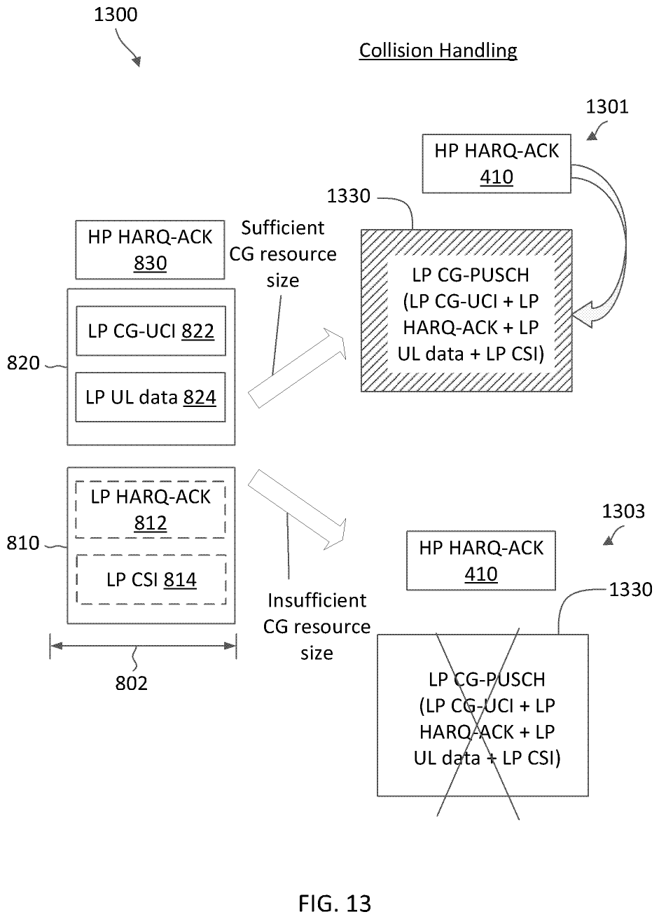

FIG. 13 illustrates an uplink transmission scheme 1300 for transmissions of different priorities according to one or more aspects of the present disclosure. The scheme 1300 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1300. The scheme 1300 is discussed using the same transmission scheduling/configuring scenario as in FIG. 8, and may use the same reference numerals as in FIG. 8 for simplicity's sake.

In the scheme 1300, when the UE 115 is scheduled to transmit LP UCI 810 and HP HARQ-ACK information 830 in a time period 802 overlapping with a CG resource for a LP CG-PUSCH transmission 820, the UE 115 generates an UL communication signal by multiplexing LP UCI 810 with the LP CG-UCI 822 and the LP UL data 824 of the same priority into the LP CG-PUSCH transmission 820 according to certain resource mapping rules or multiplexing order and then multiplexes across the multiplexed LP CG-PUSCH transmission and the HP HARQ-ACK information 830 of different priorities. The LP UCI 810 may include LP HARQ-ACK information 812 and/or LP CSI 814 (which may include CSI part 1 and CSI part 2).

In the illustrated example of FIG. 13, the CG resource is shown as 1330 in the right side of FIG. 13. The CG resource 1330 may include a plurality of REs (e.g., REs 212) in a number of symbols (e.g., symbols 206) in time and a number of subcarriers (e.g., subcarriers 204) in frequency. As shown by 1301, the LP CG-PUSCH transmission 820 including the LP HARQ-ACK information 812 and/or the LP CSI 814 multiplexed with the LP CG-UCI 822 and the LP UL data 824 in the CG resource 1330. Subsequently, the UE 115 further maps the HP HARQ-ACK information 830 to remaining REs in the CG resource 1330 shown by the curved arrow. The mapping may include generating an UL communication signal (a LP CG-PUSCH transmission) including frequency points corresponding to the mapped information in the order of the mapping as discussed above in relation to FIG. 8. Subsequently, the UE 115 transmits the UL communication signal in the LP CG resource 1330.

In some aspects, the UE 115 separately encodes each of the LP HARQ-ACK information 812, CSI part 1 of LP CSI 814, CSI part 2 of LP CSI 814, LP CG-UCI 822, and HP HARQ-ACK information 830 the mapping may be performed on the separately encoded bits. In some aspects, the UE 115 may jointly encode the LP HARQ-ACK information 812 and the LP CG-UCI 822 of the same priority into a single code block as discussed above in relation to FIG. 3. In some aspects, the UE 115 may be limited to multiplex a threshold number of separately encoded UCI code blocks (e.g., a maximum of separately three UCI code blocks). If the number of separately encoded UCI code blocks exceed the threshold, the UE 115 may remove CSI part 2 of LP CSI 814 from the transmission. In some other aspects, the threshold may be set to 4, and thus the UE 115 may include the HP HARQ-ACK information 830, CSI part 1 of LP CSI 814, CSI part 2 of LP CSI 814, and the jointly encoded LP HARQ-ACK information 812 and the LP CG-UCI 822.

In some instances, the CG resource 1330 may not be sufficient (e.g., a sufficient number of REs) in carrying the multiplexed LP CG-PUSCH transmission 820. As shown by 1303, when the CG resource 1330 is not sufficient, the UE 115 may transmit the HP HARQ-ACK information 830 in a PUCCH resource (within the time period 802) scheduled for the HP HARQ-ACK information 830 and refrain from transmitting (drop) the multiplexed LP CG-PUSCH transmission including the LP HARQ-ACK information 812 and/or the LP CSI 814 multiplexed with the LP CG-UCI 822 and the LP UL data 824 (shown by the cross symbol “X”).

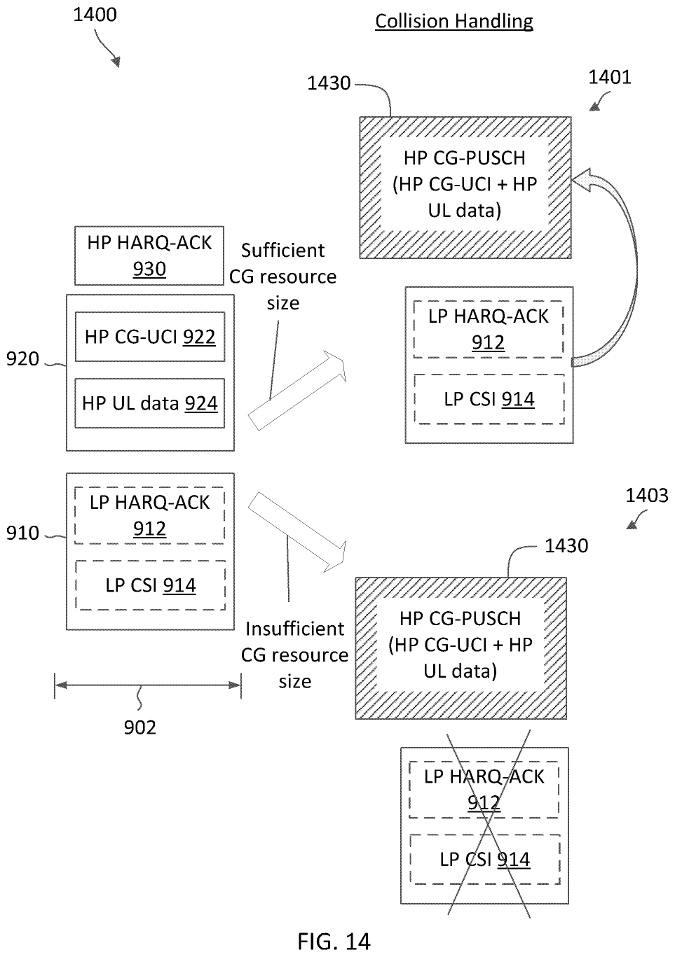

FIG. 14 illustrates an uplink transmission scheme 1400 for transmissions of different priorities according to one or more aspects of the present disclosure. The scheme 1400 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1400. The scheme 1400 is discussed using the same transmission scheduling/configuring scenario as in FIG. 9, and may use the same reference numerals as in FIG. 9 for simplicity's sake.

In the scheme 1400, when the UE 115 is scheduled to transmit LP UCI 910 and HP HARQ-ACK information 930 in a time period 802 overlapping with a CG resource for a HP CG-PUSCH transmission 920, the UE 115 generates an UL communication signal by multiplexing HP HARQ-ACK information 930 with the HP CG-UCI 922 and the HP UL data 924 of the same priority into the HP CG-PUSCH transmission 920 according to certain resource mapping rules or multiplexing order and then multiplexes across the multiplexed HP CG-PUSCH transmission 920 and the HP HARQ-ACK information 930 of different priorities. The LP UCI 910 may include LP HARQ-ACK information 912 and/or LP CSI 914 (which may include CSI part 1 and CSI part 2).

In the illustrated example of FIG. 14, the CG resource is shown as 1430 in the right side of FIG. 14. The CG resource 1430 may include a plurality of REs (e.g., REs 212) in a number of symbols (e.g., symbols 206) in time and a number of subcarriers (e.g., subcarriers 204) in frequency. As shown by 1401, the HP CG-PUSCH transmission 920 including the HP HARQ-ACK information 930 multiplexed with the HP CG-UCI 922 and the HP UL data 924 in the CG resource 1430. Subsequently, the UE 115 further maps the LP UCI 910 to remaining REs in the CG resource 1330 shown by the curved arrow. The mapping may include generating an UL communication signal (a HP CG-PUSCH transmission) including frequency points corresponding to the mapped information in the order of the mapping as discussed above in relation to FIG. 8. Subsequently, the UE 115 transmits the UL communication signal in the HP CG resource 1430.

In some aspects, the UE 115 separately encodes each of the LP HARQ-ACK information 912, CSI part 1 of LP CSI 914, CSI part 2 of LP CSI 914, HP CG-UCI 922, and HP HARQ-ACK information 930 the mapping map be performed on the separately encoded bits. In some aspects, the UE 115 may jointly encode the HP HARQ-ACK information 930 and the HP CG-UCI 922 of the same priority into a single code block as discussed above in relation to FIG. 3. In some aspects, the UE 115 may be limited to multiplex a threshold number of separately encoded UCI code blocks (e.g., a maximum of separately three UCI code blocks). If the number of separately encoded UCI code blocks exceed the threshold, the UE 115 may remove CSI part 2 of LP CSI 914 from the transmission. In some other aspects, the threshold may be set to 4, and thus the UE 115 may include the LP HARQ-ACK information 912, CSI part 1 of LP CSI 914, CSI part 2 of LP CSI 914, and the jointly encoded HP HARQ-ACK information 930 and the HP CG-UCI 922.

In some instances, the CG resource 1430 may not be sufficient (e.g., a sufficient number of REs) in carrying the multiplexed HP CG-PUSCH transmission 920. As shown by 1403, when the CG resource 1430 is not sufficient, the UE 115 transmit the multiplexed HP CG-PUSCH transmission 920 in the CG resource 1430 and refrain from transmitting the LP HARQ-ACK information 912 and/or LP CSI 914 in PUCCH resource(s) (within the time period 902) scheduled for the LP HARQ-ACK information 912 and/or LP CSI 914 (shown by the cross symbol “X”).

FIGS. 15-17 illustrate various mechanisms for handling collisions among UCI and CG-UCI of different traffic priorities by multiplexing the different traffic priorities UCI and CG-UCI according to a certain multiplexing priority order.

FIG. 15 illustrates an uplink transmission scheme 1500 for transmissions of different priorities according to one or more aspects of the present disclosure. The scheme 1500 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1500. The scheme 1500 is discussed using the same transmission scheduling/configuring scenario as in FIG. 8, and may use the same reference numerals as in FIG. 8 for simplicity's sake.

In the scheme 1500, when the UE 115 is scheduled to transmit LP UCI 810 and HP HARQ-ACK information 830 in a time period 802 overlapping with a CG resource for a LP CG-PUSCH transmission 820, the UE 115 generates an UL communication signal by multiplexing the LP UCI 810, the HP HARQ-ACK information 830 with the LP CG-UCI 822 and the LP UL data 824 into the LP CG-PUSCH transmission 820 according to a multiplexing priority order. The LP UCI 810 may include LP HARQ-ACK information 812 and/or LP CSI 814. The LP CG-PUSCH transmission 820 includes LP CG-UCI 822 and LP UL data 824. In some aspects, the multiplexing priority order from a highest multiplexing priority to a lowest multiplexing priority includes HP HARQ-ACK information, LP CG-UCI (or jointly encoded LP CG-UCI with LP HARQ-ACK information), CSI part 1, CSI part 2, and LP UL data.

In the illustrated example of FIG. 15, the CG resource is shown as 1530 in the right side of FIG. 15. The CG resource 1530 may include a plurality of REs (e.g., REs 212) in a number of symbols (e.g., symbols 206) in time and a number of subcarriers (e.g., subcarriers 204) in frequency. At 1502, the UE 115 maps the HP HARQ-ACK information 830 to a first set of REs in the CG resource 1530 according to a certain resource mapping rule.

At 1504, after mapping the HP HARQ-ACK information 830, the UE 115 maps the jointly encoded LP HARQ-ACK information 812 and LP CG-UCI 822 (shown as 1510) to one or more of the remaining REs the CG resource 1530 according to the resource mapping rule. In some other instances, if the LP UCI 810 does not include LP HARQ-ACK information 812, the UE 115 may map the LP CG-UCI 822 alone at 1504.

At 1506, after mapping the jointly encoded LP HARQ-ACK information 812 and LP CG-UCI 822, the UE 115 maps the LP CSI 814 to one or more of the remaining REs the CG resource 1530 according to the resource mapping rule. In some instances, the LP CSI 814 may include CSI part 1 and CSI part 2, and the UE 115 may map CSI part 1 of LP CSI 814 to the CG resource 1530 before mapping the CSI part 2 of LP CSI 814 to the CG resource 1530. In some instances, the LP UCI 810 may not include LP CSI 914, and thus the UE 115 may skip the mapping at 1506.

At 1508, after mapping the LP CSI 814, the UE 115 maps the LP UL data 824 to one or more of the remaining REs the CG resource 1530 according to the resource mapping rule.

The mapping may include generating an UL communication signal (a HP CG-PUSCH transmission) including frequency points corresponding to the mapped information in the order of the mapping as discussed above in relation to FIG. 8. Subsequently, the UE 115 transmits the UL communication signal in the HP CG resource 1530.

In some aspects, the UE 115 separately encodes each of the LP HARQ-ACK information 812, CSI part 1 of LP CSI 814, CSI part 2 of LP CSI 814, LP CG-UCI 822, and HP HARQ-ACK information 830 the mapping may be performed on the separately encoded bits. In some aspects, the UE 115 may jointly encode the LP HARQ-ACK information 812 and the LP CG-UCI 822 of the same priority into a single code block as discussed above in relation to FIG. 3. In some aspects, the UE 115 may be limited to multiplex a threshold number of separately encoded UCI code blocks (e.g., a maximum of separately three UCI code blocks). If the number of separately encoded UCI code blocks exceed the threshold, the UE 115 may remove CSI part 2 of LP CSI 814 from the transmission. In some other aspects, the threshold may be set to 4, and thus the UE 115 may include the HP HARQ-ACK information 830, CSI part 1 of LP CSI 814, CSI part 2 of LP CSI 814, and the jointly encoded LP HARQ-ACK information 812 and the LP CG-UCI 822.

In some instances, the CG resource 1530 may not be sufficient (e.g., a sufficient number of REs) in carrying the HP HARQ-ACK information 830, the LP HARQ-ACK information 812, LP CG-UCI 822, the CSI part 1 of CSI 814, the CSI part 2 of CSI 814, and the LP UL data 824. When the CG resource 1530 is not sufficient, the UE 115 may refrain from multiplexing (drop) the LP UL data 824 and/or the LP CSI part 1 of CSI 814 and/or CSI part 2 of CSI 814 into the LP CG PUSCH transmission 820. For instance, the UE 115 may drop the multiplexing part in a reverse order of the multiplexing priority order. In an example, the UE 115 may first drop the LP UL data 824. If the CG resource 1530 is still insufficient, the UE 115 may drop the LP CSI 814. In other words, for each mapping, the UE 115 may determine whether a number of remaining REs in the CG resource 1530 is sufficient for the mapping. If there is not a sufficient number of remaining REs, the UE 115 may not proceed with the mapping.

In some aspects, the UE 115 separately encodes each of the LP HARQ-ACK information 812, CSI part 1 of LP CSI 814, CSI part 2 of LP CSI 814, LP CG-UCI 822, and HP HARQ-ACK information 830 the mapping may be performed on the separately encoded bits. In some aspects, the UE 115 may jointly encode the LP HARQ-ACK information 812 and the LP CG-UCI 822 of the same priority into a single code block as discussed above in relation to FIG. 3. In some aspects, the UE 115 may be limited to multiplex a threshold number of separately encoded UCI code blocks (e.g., a maximum of separately three UCI code blocks). If the number of separately encoded UCI code blocks exceed the threshold, the UE 115 may remove CSI part 2 of LP CSI 814 from the transmission. In some other aspects, the threshold may be set to 4, and thus the UE 115 may include the HP HARQ-ACK information 830, CSI part 1 of LP CSI 814, CSI part 2 of LP CSI 814, and the jointly encoded LP HARQ-ACK information 812 and the LP CG-UCI 822.

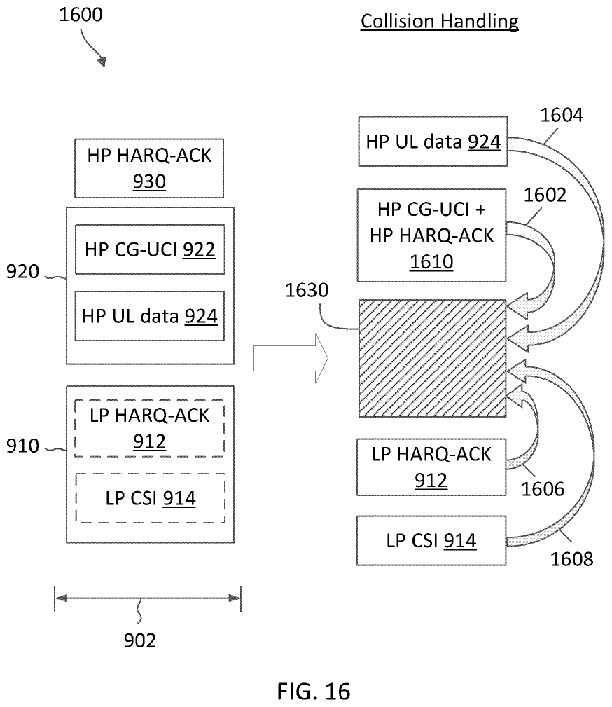

FIG. 16 illustrates an uplink transmission scheme 1600 for transmissions of different priorities according to one or more aspects of the present disclosure. The scheme 1600 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1600. The scheme 1600 is discussed using the same transmission scheduling/configuring scenario as in FIG. 9, and may use the same reference numerals as in FIG. 9 for simplicity's sake.

In the scheme 1600, when the UE 115 is scheduled to transmit LP UCI 910 and HP HARQ-ACK information 930 in a time period 802 overlapping with a CG resource for a HP CG-PUSCH transmission 920, the UE 115 generates an UL communication signal by multiplexing the LP UCI 910, the HP HARQ-ACK information 930, the HP CG-UCI 922, and the HP UL data 924 according to a multiplexing priority order. The LP UCI 910 may include LP HARQ-ACK information 912 and/or LP CSI 914 CSI part 1 and CSI part 2). The HP CG-PUSCH transmission 920 includes HP CG-UCI 922 and HP UL data 924. In some aspects, the multiplexing priority order from the highest multiplexing priority to the lowest multiplexing priority comprises HP CG-UCI (or jointly coded HP CG-UCI and HP HARQ-ACK information), HP UL data, LP HARQ-ACK information, CSI part 1, and CSI part 2.

In the illustrated example of FIG. 16, the CG resource is shown as 1630 in the right side of FIG. 16. The CG resource 1630 may include a plurality of REs (e.g., REs 212) in a number of symbols (e.g., symbols 206) in time and a number of subcarriers (e.g., subcarriers 204) in frequency. At 1602, the UE 115 maps the jointly encoded HP HARQ-ACK information 930 and HP CG-UCI 922 (shown as 1610) to a first set of REs in the CG resource 1630 according to a certain resource mapping rule.

At 1604, after mapping the jointly encoded LP HARQ-ACK information 812 and LP CG-UCI 822, the UE 115 maps the HP UL data 924 to one or more of the remaining REs the CG resource 1630 according to the resource mapping rule.

At 1606, after mapping the HP UL data 924, the UE 115 maps the LP HARQ-ACK information 912 to one or more of the remaining REs the CG resource 1630 according to the resource mapping rule. In some instances, the LP UCI 910 may not include LP HARQ-ACK information 912, and thus the UE 115 may skip the mapping at 1606.

At 1608, after mapping the LP HARQ-ACK information 912, the UE 115 maps the LP CSI 914 to one or more of the remaining REs the CG resource 1630 according to the resource mapping rule. In some instances, the LP CSI 914 may include CSI part 1 and CSI part 2, and the UE 115 may map CSI part 1 of LP CSI 914 to the CG resource 1630 before mapping the CSI part 2 of LP CSI 914 to the CG resource 1630. In some instances, the LP UCI 910 may not include LP CSI 914, and thus the UE 115 may skip the mapping at 1608.

The mapping may include generating an UL communication signal (a HP CG-PUSCH transmission) including frequency points corresponding to the mapped information in the order of the mapping as discussed above in relation to FIG. 8. Subsequently, the UE 115 transmits the UL communication signal in the HP CG resource 1630.

In some instances, the CG resource 1630 may not be sufficient (e.g., a sufficient number of REs) in carrying the HP CG-UCI 922, the HP HARQ-ACK information 930, the HP UL data 924, the LP HARQ-ACK information 912, the CSI part 1 of CSI 914, and the CSI part 2 of CSI 914. When the CG resource 1630 is not sufficient, the UE 115 may refrain from multiplexing (drop) the LP HARQ-ACK information 912, and/or LP CSI 914 into the HP CG PUSCH transmission 920. For instance, the UE 115 may drop the multiplexing part in a reverse order of the multiplexing priority order. In an example, the UE 115 may drop the LP CSI 914. If the CG resource 1630 is still insufficient, the UE 115 may drop the LP HARQ-ACK information 912. In other words, for each mapping, the UE 115 may determine whether a number of remaining REs in the CG resource 1630 is sufficient for the mapping. If there is not a sufficient number of remaining REs, the UE 115 may not proceed with the mapping.

In some aspects, the UE 115 separately encodes each of the LP HARQ-ACK information 912, CSI part 1 of LP CSI 914, CSI part 2 of LP CSI 914, HP CG-UCI 922, and HP HARQ-ACK information 930 the mapping may be performed on the separately encoded bits. In some aspects, the UE 115 may jointly encode the HP HARQ-ACK information 930 and the HP CG-UCI 922 of the same priority into a single code block as discussed above in relation to FIG. 3. In some aspects, the UE 115 may be limited to multiplex a threshold number of separately encoded UCI code blocks (e.g., a maximum of separately three UCI code blocks). If the number of separately encoded UCI code blocks exceed the threshold, the UE 115 may remove CSI part 2 of LP CSI 914 from the transmission. In some other aspects, the threshold may be set to 4, and thus the UE 115 may include the LP HARQ-ACK information 912, CSI part 1 of LP CSI 914, CSI part 2 of LP CSI 914, and the jointly encoded HP HARQ-ACK information 930 and the HP CG-UCI 922.

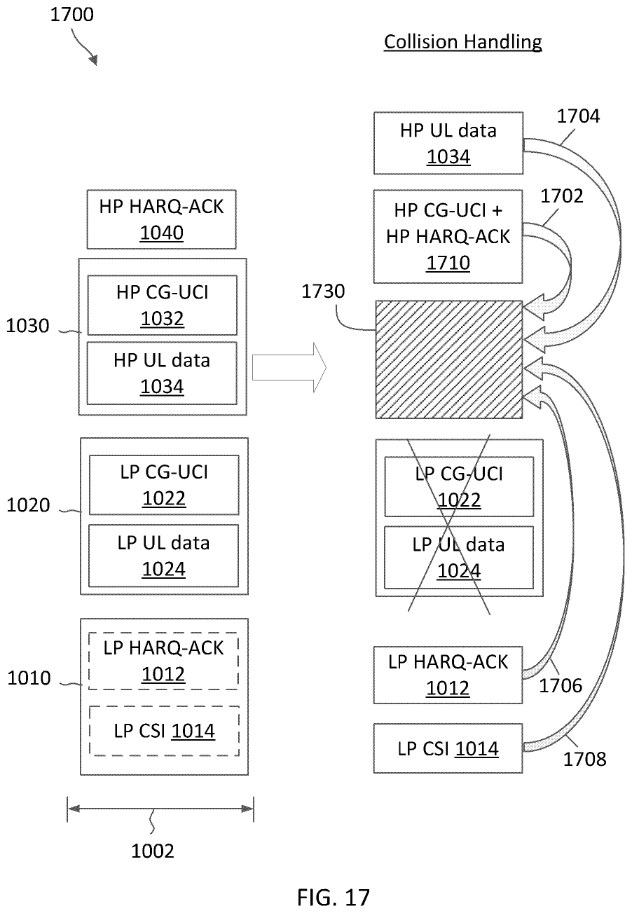

FIG. 17 illustrates an uplink transmission scheme 1700 for transmissions of different priorities according to one or more aspects of the present disclosure. The scheme 1700 may be employed by BSs such as the BSs 105 and UEs such as the UEs 115 in a network such as the network 100 for UL communications. In particular, a UE 115 may handle an overlap or collision between scheduled UCI and CG-UCI of different priorities as shown in the scheme 1700. The scheme 1700 is discussed using the same transmission scheduling/configuring scenario as in FIG. 10, and may use the same reference numerals as in FIG. 10 for simplicity's sake.

In the scheme 1700, when the UE 115 is scheduled to transmit LP UCI 1010 and HP HARQ-ACK information 1040 in a time period 1002 overlapping with a LP CG resource for a LP CG-PUSCH transmission 1020, and a HP CG resource for a HP CG-PUSCH transmission 1030, the UE 115 generates an UL communication signal by multiplexing the LP UCI 1010, the HP HARQ-ACK information 1040, the LP CG-PUSCH transmission 1020, and the HP CG-PUSCH transmission 1030 according to a multiplexing priority order. The LP UCI 1010 may include LP HARQ-ACK information 1012 and/or LP CSI 914. The LP CG-PUSCH transmission 1020 includes LP CG-UCI 1022 and LP UL data 1024. The HP CG-PUSCH transmission 1030 includes HP CG-UCI 1032 and HP UL data 1034. In some aspects, the multiplexing priority order may include first dropping the LP CG-PUSCH transmission 1020 including the LP CG-UCI 1022 and the LP UL data 1024, and then from the highest multiplexing priority to the lowest multiplexing priority includes HP CG-UCI (or jointly coded HP CG-UCI and HP HARQ-ACK information), HP UL data, LP HARQ-ACK information, CSI part 1, and CSI part 2 similar to the multiplexing priority order in the scheme 1600 discussed above with relation to FIG. 16.

In the illustrated example of FIG. 17, the CG resource is shown as 1730 in the right side of FIG. 17. The CG resource 1730 may include a plurality of REs (e.g., REs 212) in a number of symbols (e.g., symbols 206) in time and a number of subcarriers (e.g., subcarriers 204) in frequency. The UE 115 may first drop the LP the LP CG-PUSCH transmission 1020 including the LP CG-UCI 1022 and the LP UL data 1024 (shown by the symbols “X”). In other words, the UE 115 may refrain from transmitting the LP CG-PUSCH transmission 1020 in the LP CG resource. After dropping the LP CG-PUSCH transmission 1020, the UE 115 may perform similar mappings as in the scheme 1600 discussed above. For instance, the mapping operations at 1702, 1704, 1706, and 1708 are similar to the mapping operations at 1602, 1604, 1606, and 1608, respectively. Accordingly, for sake of brevity, details of those mapping operations will not be repeated here. Please refer to the corresponding descriptions above.

In some aspects, a UE 115 may use any suitable combinations of the schemes 400-1700 to resolve collision between scheduled UCI and CG-UCI of different priorities on a CG-PUSCH transmission or collision between different priority CG-PUSCH transmissions with CG-UCI. In some aspects, a BS 105 may configure a UE 115 to utilize the low-priority transmission dropping mechanisms discussed above in relation to FIGS. 4-10 to utilize the multiplexing prioritization mechanisms discussed above in relation to FIGS. 11-17 to resolve collision among UCI and CG-UCI of different priorities. For instance, the BS 105 may configure an indicator indicating which of the low-priority transmission dropping mechanisms or the multiplexing prioritization mechanisms the UE 115 may use to resolve a collision.

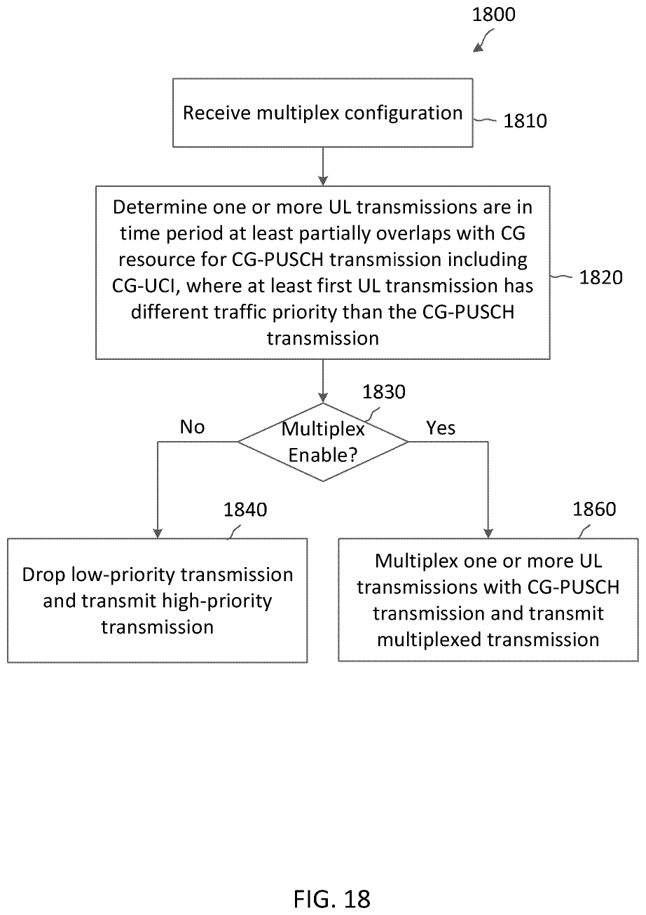

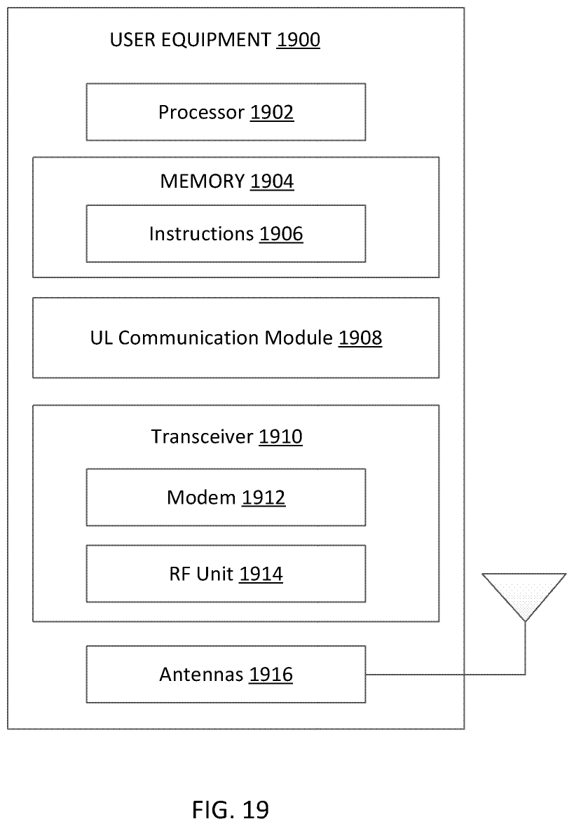

FIG. 18 is a flow diagram of an uplink transmission method 1800 for transmissions of different priorities according to some aspects of the present disclosure. Aspects of the method 1800 can be executed by a UE, such as the UEs 115 and/or the UE 1900 shown of FIG. 19. A UE may comprise a processor, processing circuit, and/or any other suitable component or means for performing the steps. For example, a UE 1900 may utilize one or more components, such as the processor 1902, the memory 1904, the UL communication module 1908, the transceiver 1910, the modem 1912, and the one or more antennas 1916, to execute the steps of method 1800. The method 1800 may employ similar mechanisms as discussed above with respect to FIGS. 4-17. As illustrated, the method 1800 includes a number of enumerated steps, but aspects of the method 1800 may include additional steps before, after, and in between the enumerated steps. In some aspects, one or more of the enumerated steps may be omitted or performed in a different order.

At block 1810, a UE (e.g., a UE 115 or 1900) receives a multiplex configuration, for example, from a BS (e.g., a BS 105 or 2000). In some aspects, the multiplex configuration may be an RRC configuration may indicate whether multiplexing of different priority HARQ-ACK information with CG-UCI is enabled or disabled. For instance, the multiplex configuration may include a flag set to a value of 1 (e.g., a multiplexing enabling indicator) to enable the multiplexing or set to a value of 0 (e.g., a multiplexing enabling indicator) to disable the multiplexing, or vice versa. In some other aspects, the multiplex configuration may refer to whether the UE is configured with a specific RRC configuration. For instance, if the UE is configured with the specific RRC (e.g., the specific RRC configuration is present at the UE), the multiplexing configuration is enabled or if the UE is not configured with the specific RRC configuration (e.g., the specific RRC configuration is not present at the UE), the multiplexing configuration is disabled.

At block 1820, the UE 115 determines that one or more uplink transmissions including UCI and/or CG-UCI are in a time period that at least overlaps with a CG resource for a CG-PUSCH transmission including CG-UCI. The one or more uplink transmission may include at least a first uplink transmission having a different traffic priority than the CG-PUSCH transmission including the CG-UCI as discussed above in relation to FIGS. 4-18. For instance, the one or more uplink transmissions include at least HP HARQ-ACK information and the CG-PUSCH transmission is a LP CG-PUSCH transmission. The one or more uplink transmission may further include one or more LP UCI, such as LP HARQ-ACK information and/or CSI. In some other instances, the one or more uplink transmissions include at least LP UCI, such as LP HARQ-ACK information and/or CSI, and the CG-PUSCH transmission is a HP CG-PUSCH transmission. The one or more uplink transmission may further include HP HARQ-ACK information and/or a LP CG-PUSCH transmission.

At block 1830, the UE determines whether multiplexing of different priority HARQ-ACK information with CG-UCI is enabled, for example, based on the configuration received at block 1810. If the UE determines that the multiplexing of different priority HARQ-ACK information with CG-UCI is disabled, the UE proceeds to block 1840.

At block 1840, the UE drops a lower priority transmission between the one or more UL transmissions and the CG-PUSCH transmission and transmits a higher priority transmission between the one or more UL transmissions and the CG-PUSCH transmission as discussed above in relation to FIGS. 4-10.

Returning to the block 1830, if the UE determines that the multiplexing of different priority HARQ-ACK information with CG-UCI is enabled, the UE proceeds to block 1850. At block 1850, the UE generates a multiplexed transmission by multiplexing the one or more UL transmissions with the CG-PUSCH transmission and transmits the multiplexed transmission as discussed above in FIGS. 11-17.

In some aspects, when the UE 115 determines that HP HARQ-ACK information is scheduled in a time period at least partially overlapping with a LP CG-PUSCH transmission, the UE 115 may select between the scheme 400 (LP transmission dropping mechanisms) and the scheme 1100 (LP and HP transmissions multiplexing mechanisms) based on the multiplex configuration received at block 1810. In some aspects, when the UE 115 determines that LP HARQ-ACK is scheduled in a time period at least partially overlapping with a HP CG-PUSCH transmission, the UE 115 may select between the scheme 500 (LP transmission dropping mechanisms) and the scheme 1200 (LP and HP transmissions multiplexing mechanisms) based on the multiplex configuration received at block 1810. In some aspects, when the UE 115 determines that HP HARQ-ACK information and LP UCI (e.g., LP HARQ-ACK information and/or LP CSI) are scheduled in a time period at least partially overlapping with a LP CG-PUSCH transmission, the UE 115 may select between the scheme 800 (LP transmission dropping mechanisms) and the scheme 1300 (LP and HP transmissions multiplexing mechanisms) based on the multiplex configuration received at block 1810. In some aspects, when the UE 115 determines that HP HARQ-ACK information and LP UCI (e.g., LP HARQ-ACK information and/or LP CSI) are scheduled in a time period at least partially overlapping with a HP CG-PUSCH transmission, the UE 115 may select between the scheme 900 and the scheme 1400 based on the multiplex configuration received at block 1810.

In some aspects, when the UE 115 determines that HP HARQ-ACK information and LP UCI (e.g., LP HARQ-ACK information and/or LP CSI) are scheduled in a time period at least partially overlapping with a LP CG-PUSCH transmission, the UE 115 may select between the scheme 800 (LP transmission dropping mechanisms) and the scheme 1500 (LP and HP transmissions multiplexing mechanisms) based on the multiplex configuration received at block 1810. In some aspects, when the UE 115 determines that HP HARQ-ACK information and LP UCI (e.g., LP HARQ-ACK information and/or LP CSI) are scheduled in a time period at least partially overlapping with a HP CG-PUSCH transmission, the UE 115 may select between the scheme 900 (LP transmission dropping mechanisms) and the scheme 1600 (LP and HP transmissions multiplexing mechanisms) based on the multiplex configuration received at block 1810. In some aspects, when the UE 115 determines that HP HARQ-ACK information, LP UCI (e.g., LP HARQ-ACK information and/or LP CSI), and a LP CG-PUSCH transmission are scheduled in a time period at least partially overlapping with a HP CG-PUSCH transmission, the UE 115 may select between the scheme 1000 (LP transmission dropping mechanisms) and the scheme 1700 (LP and HP transmissions multiplexing mechanisms) based on the multiplex configuration received at block 1810.

FIG. 19 is a block diagram of an exemplary UE 1900 according to some aspects of the present disclosure. The UE 1900 may be a UE 115 discussed above in FIG. 1. As shown, the UE 1900 may include a processor 1902, a memory 1904, a UL communication module 1908, a transceiver 1910 including a modem subsystem 1912 and a radio frequency (RF) unit 1914, and one or more antennas 1916. These elements may be in direct or indirect communication with each other, for example via one or more buses.

The processor 1902 may have various features as a specific-type processor. For example, these may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1902 may also be implemented as a combination of computing devices, e.g., a combination of a DSP and a microprocessor, a plurality of microprocessors, one or more microprocessors in conjunction with a DSP core, or any other such configuration.

The memory 1904 may include a cache memory (e.g., a cache memory of the processor 1902), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some aspects, the memory 1904 may include a non-transitory computer-readable medium. The memory 1904 may store, or have recorded thereon, instructions 1906. The instructions 1906 may include instructions that, when executed by the processor 1902, cause the processor 1902 to perform the operations described herein with reference to the UEs 115 in connection with aspects of the present disclosure, for example, aspects of FIGS. 1-18 and 21-25. Instructions 1906 may also be referred to as program code. The program code may be for causing a wireless communication device to perform these operations, for example by causing one or more processors (such as processor 1902) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The UL communication module 1908 may be implemented via hardware, software, or combinations thereof. For example, the UL communication module 1908 may be implemented as a processor, circuit, and/or instructions 1906 stored in the memory 1904 and executed by the processor 1902. In some instances, the UL communication module 1908 can be integrated within the modem subsystem 1912. For example, the UL communication module 1908 can be implemented by a combination of software components (e.g., executed by a DSP or a general processor) and hardware components (e.g., logic gates and circuitry) within the modem subsystem 1912.

The UL communication module 1908 may communicate with various components of the UE 1900 to perform various aspects of the present disclosure, for example, aspects of FIGS. 1-18 and 21-25. For instance, the UL communication module 1908 is configured to receive dynamic scheduling grant for UL transmissions. The UL transmissions may include PUSCH transmissions carrying UL data and/or PUCCH transmissions carrying UCI (e.g., HARQ-ACK information). Each scheduling grant may indicate a traffic priority (e.g., a low priority or a high priority) for a corresponding UL transmission. The UL communication module 1908 is also configured to receive allocation of PUCCH resources for CSI reporting (e.g., UCI), which may be of a low traffic priority. The UL communication module 1908 is also configured to receive CG grants indicating CG resources for UL communications (e.g., CG-PUSCH transmissions). Each configured grant may also indicate a traffic priority (e.g., a low priority or a high priority) for a corresponding CG resource. A CG-PUSCH transmission may include CG UL data (unscheduled UL data) and CG-UCI providing information (e.g., HARQ process ID, RV, NDI) related to the CG UL data. In some aspects, the UL communication module 1908 is configured to determine that a UCI message (e.g., including HARQ-ACK information) associated with a first priority is scheduled in a time period that at least partially overlaps (collides) with a CG resource for a CG-PUSCH transmission associated with a second priority different from the first priority. In some aspects, the UL communication module 1908 is configured to resolve the collision by refraining from transmitting (dropping) a lower priority transmission between the UCI message and the CG-PUSCH transmission and transmit a higher priority transmission between the UCI message and the CG-PUSCH transmission, for example, as discussed above in relation to FIGS. 4-7. In some other aspects, the UL communication module 1908 is configured to resolve the collision by multiplexing the UCI message of the first priority and CG-UCI and UL data of the second, different priority in the CG-PUSCH transmission and transmit the multiplexed CG-PUSCH transmission, for example, as discussed above in relation to FIGS. 11-12. In some aspects, the BS may configure the UE with a multiplex configuration for multiplexing HARQ-ACK information and CG-UCI of different priorities. The configuration may enable or disable multiplexing HARQ-ACK information and CG-UCI of different priorities, and the UE may determine whether to drop a lower priority transmission or multiplex the different priority UCI and CG-PUSCH transmissions based on the configuration, for example, as discussed above in relation to FIG. 18.

In some aspect, multiple UCI messages (e.g., high-priority (HP) HARQ-ACK information and at least one of low-priority (LP) HARQ-ACK information and/or LP CSI) are scheduled/configured in a time period that at least partially overlaps with a first CG resource for a first CG-PUSCH transmission (including CG-UCI and CG UL data) associated with a high priority or a low priority. In some aspects, the UL communication module 1908 is configured to perform multiplexing among transmissions of the same priority before dropping a lower priority transmission, for example, as discussed above in relation to FIGS. 8-10. In some aspects, the UL communication module 1908 is configured to perform multiplexing among transmissions of the same priority before multiplexing across transmissions of different priorities, as discussed above in relation to FIGS. 13-14. In some aspects, the UL communication module 1908 is configured to multiplex the UCI messages, the CG-UCI, the CG UL data according to a multiplexing priority order decoupled from the traffic priorities of the UCI messages, the CG-UCI, and the CG UL data, for example, as discussed above in relation to FIGS. 15-17.

As shown, the transceiver 1910 may include the modem subsystem 1912 and the RF unit 1914. The transceiver 1910 can be configured to communicate bi-directionally with other devices, such as the BSs 105. The modem subsystem 1912 may be configured to modulate and/or encode data according to a MCS, e.g., a LDPC coding scheme, a turbo coding scheme, a convolutional coding scheme, a polar coding scheme, a digital beamforming scheme, etc. The RF unit 1914 may be configured to process (e.g., perform analog to digital conversion or digital to analog conversion, etc.) modulated/encoded data (e.g., scheduled UCI, scheduled UL data, CG-UCI, CG UL data, PUCCH UCI, PUSCH data, HARQ-ACK, CSI part 1, CSI part 2) from the modem subsystem 1912 (on outbound transmissions) or of transmissions originating from another source such as a UE 115 or a BS 105. The RF unit 1914 may be further configured to perform analog beamforming in conjunction with the digital beamforming. Although shown as integrated together in transceiver 1910, the modem subsystem 1912 and/or the RF unit 1914 may be separate devices that are coupled together at the UE 1900 to enable the UE 1900 to communicate with other devices.

The RF unit 1914 may provide the modulated and/or processed data, e.g. data packets (or, more generally, data messages that may contain one or more data packets and other information), to the antennas 1916 for transmission to one or more other devices. The antennas 1916 may further receive data messages transmitted from other devices and provide the received data messages for processing and/or demodulation at the transceiver 1910. The transceiver 1910 may provide the demodulated and decoded data (e.g., DL data, DCI, scheduling grants, RRC configuration, MAC CE, CG configuration, CG grants, HARQ-ACK/CG-UCI multiplex configuration) from the modem subsystem 2012 (on outbound transmissions) to the UL communication module 1908 for processing. The antennas 1916 may include multiple antennas of similar or different designs in order to sustain multiple transmission links.

In an aspect, the UE 1900 can include multiple transceivers 1910 implementing different RATs (e.g., NR and LTE). In an aspect, the UE 1900 can include a single transceiver 1910 implementing multiple RATs (e.g., NR and LTE). In an aspect, the transceiver 1910 can include various components, where different combinations of components can implement different RATs.

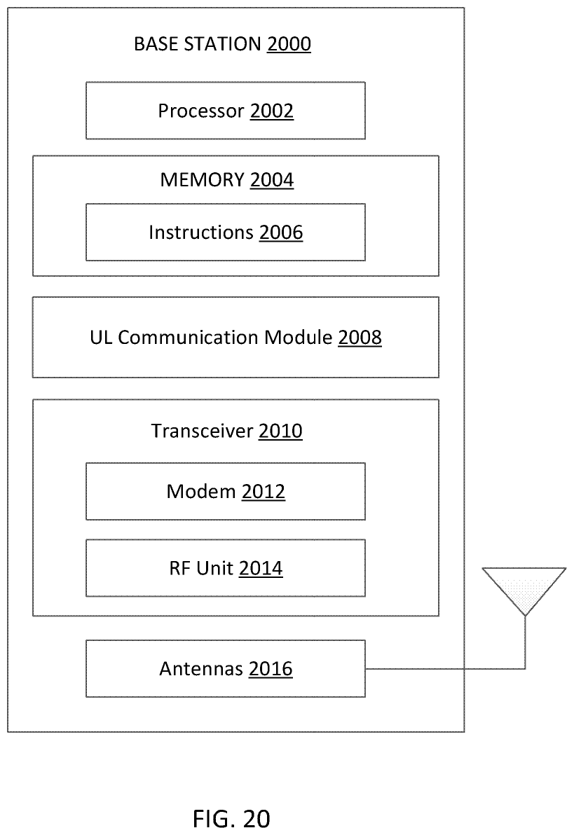

FIG. 20 is a block diagram of an exemplary BS 2000 according to some aspects of the present disclosure. The BS 2000 may be a BS 105 in the network 200 as discussed above in FIG. 1. As shown, the BS 2000 may include a processor 2002, a memory 2004, an UL communication module 2008, a transceiver 2010 including a modem subsystem 2012 and an RF unit 2014, and one or more antennas 2016. These elements may be in direct or indirect communication with each other, for example via one or more buses.

The processor 2002 may include a CPU, a DSP, an ASIC, a controller, an FPGA device, another hardware device, a firmware device, or any combination thereof configured to perform the operations described herein. The processor 2002 may also be implemented as a combination of computing devices, e.g., a combination of a DSP and a microprocessor, a plurality of microprocessors, one or more microprocessors in conjunction with a DSP core, or any other such configuration.

The memory 2004 may include a cache memory (e.g., a cache memory of the processor 2002), RAM, MRAM, ROM, PROM, EPROM, EEPROM, flash memory, solid state memory device, hard disk drives, other forms of volatile and non-volatile memory, or a combination of different types of memory. In an aspect, the memory 2004 includes a non-transitory computer-readable medium. The memory 2004 may store instructions 2006. The instructions 2006 may include instructions that, when executed by the processor 2002, cause the processor 2002 to perform operations described herein, for example, aspects of FIGS. 1-17 and 26. Instructions 2006 may also be referred to as code, which may be interpreted broadly to include any type of computer-readable statement(s) as discussed above.

The UL communication module 2008 may be implemented via hardware, software, or combinations thereof. For example, the UL communication module 2008 may be implemented as a processor, circuit, and/or instructions 2006 stored in the memory 2004 and executed by the processor 2002. In some instances, the UL communication module 2008 can be integrated within the modem subsystem 2012. For example, the UL communication module 2008 can be implemented by a combination of software components (e.g., executed by a DSP or a general processor) and hardware components (e.g., logic gates and circuitry) within the modem subsystem 2012.

The UL communication module 2008 may communicate with various components of the BS 2000 to perform various aspects of the present disclosure, for example, aspects of FIGS. 1-18 and 26. For instance, the UL communication module 2008 is configured to transmit, to a UE (e.g., a UE 115 or a UE 1900), dynamic scheduling grants for UL transmissions. The UL transmissions may include PUSCH transmissions carrying UL data and/or PUCCH transmissions carrying UCI (e.g., HARQ-ACK information and/or CSI). Each scheduling grant may indicate a traffic priority (e.g., a low priority or a high priority) for a corresponding UL transmission. The UL communication module 2008 is also configured to transmit, to the UE, a resource allocation for PUCCH resources for CSI reporting (e.g., UCI), which may be of a low traffic priority. The UL communication module 2008 is also configured to transmit, to the UE, CG grants indicating CG resources for UL communications (e.g., CG-PUSCH transmissions). Each configured grant may also indicate a traffic priority (e.g., a low priority or a high priority) for a corresponding CG resource. A CG-PUSCH transmission may include CG UL data (unscheduled UL data) and CG-UCI providing information (e.g., HARQ process ID, RV, NDI) related to the CG UL data.

In some aspects, the UL communication module 2008 is configured to transmit, to a UE, a multiplex configuration associated with a CG resource and first hybrid automatic repeat request-acknowledgment (HARQ-ACK) information of different priorities. The multiplex configuration may include a multiplex disabling indicator or a multiplex enabling indicator. In some instances, the UL communication module 2008 is configured to receive a first uplink communication signal comprising the HARQ-ACK information or CG uplink data in response to transmitting the multiplexing configuration comprising the multiplex disabling indicator. In some instances, the UL communication module 2008 is configured to receives second uplink communication signal comprising the CG uplink data multiplexed with the HARQ-ACK information in response to transmitting the multiplexing configuration comprising the multiplex enabling indicator.

In some aspects, the HARQ-ACK information is associated with a higher priority than the CG resource. In some aspects, the second uplink communication signal may further include scheduled UCI associated with the same priority as the CG uplink data, wherein the scheduled UCI may include at least one of another HARQ-ACK information or CSI.

In some aspects, the HARQ-ACK information is associated with a lower priority than the CG resource. In some aspects, the second uplink communication signal may further include CSI associated with same priority as the HARQ-ACK information.

As shown, the transceiver 2010 may include the modem subsystem 2012 and the RF unit 2014. The transceiver 2010 can be configured to communicate bi-directionally with other devices, such as the BSs 105 and/or another core network element. The modem subsystem 2012 may be configured to modulate and/or encode the data from the memory 2004 and/or the UL communication module 2008 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 2014 may be configured to process (e.g., perform analog to digital conversion or digital to analog conversion, etc.) modulated/encoded data (e.g., DL data, DCI, scheduling grants, RRC configuration, MAC CE, CG configuration, CG grants, HARQ-ACK/CG-UCI multiplex configuration) from the modem subsystem 2012 (on outbound transmissions) or of transmissions originating from another source such as a UE 115. The RF unit 2014 may be further configured to perform analog beamforming in conjunction with the digital beamforming. Although shown as integrated together in transceiver 2010, the modem subsystem 2012 and the RF unit 2014 may be separate devices that are coupled together at the BS 2000 to enable the BS 2000 to communicate with other devices.

The RF unit 2014 may provide the modulated and/or processed data, e.g. data packets (or, more generally, data messages that may contain one or more data packets and other information), to the antennas 2016 for transmission to one or more other devices. The antennas 2016 may further receive data messages transmitted from other devices. The antennas 2016 may provide the received data messages for processing and/or demodulation at the transceiver 2010. The transceiver 2010 may provide the demodulated and decoded data (e.g., scheduled UCI, scheduled UL data, CG-UCI, CG UL data, PUCCH UCI, PUSCH data, HARQ-ACK, CSI part 1, CSI part 2) to the UL communication module 2008 for processing. The antennas 2016 may include multiple antennas of similar or different designs in order to sustain multiple transmission links. The RF unit 2014 may configure the antennas 2016.

In an aspect, the BS 2000 can include multiple transceivers 2010 implementing different RATs (e.g., NR and LTE). In an aspect, the BS 2000 can include a single transceiver 2010 implementing multiple RATs (e.g., NR and LTE). In an aspect, the transceiver 2010 can include various components, where different combinations of components can implement different RATs.

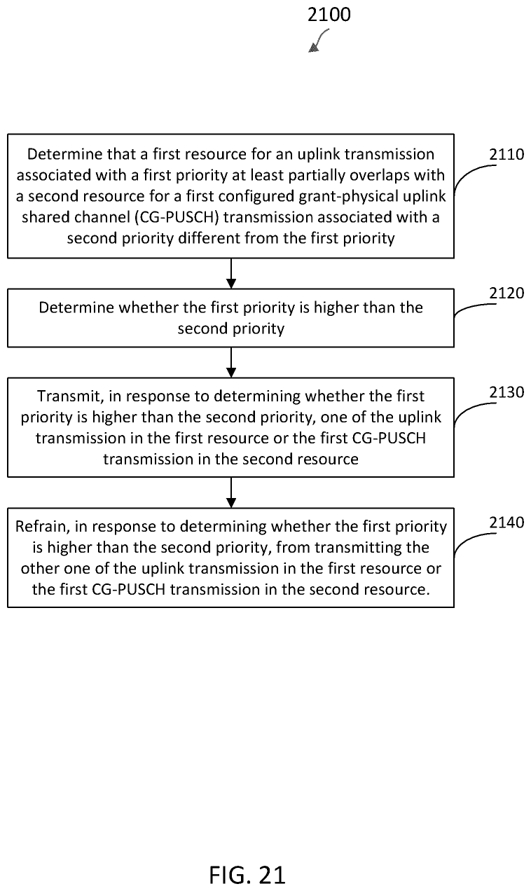

FIG. 21 is a flow diagram of a communication method 2100 according to some aspects of the present disclosure. Aspects of the method 2100 can be executed by a UE, such as the UEs 115 and/or 1900. For example, a UE 1900 may utilize one or more components, such as the processor 1902, the memory 1904, the UL communication module 1908, the transceiver 1910, the modem 1912, and the one or more antennas 1916, to execute the steps of method 2100. The method 2100 may employ similar mechanisms as discussed above with respect to FIGS. 1-7 and 18. As illustrated, the method 2100 includes a number of enumerated steps, but aspects of the method 2100 may include additional steps before, after, and in between the enumerated steps. In some aspects, one or more of the enumerated steps may be omitted or performed in a different order.

At block 2110, a UE (e.g., a UE 115 or a UE 1900) determines that a first resource for an uplink transmission associated with a first priority at least partially overlaps with a second resource for a first CG-PUSCH transmission associated with a second priority different from the first priority. In some aspects, the UE may receive schedule(s) or configuration(s) for the uplink transmission from a BS, where the schedule(s) or configuration(s) may indicate the first priority (e.g., a high traffic priority or a low traffic priority) and the first resource for the uplink transmission. The UE may further receive a configured grant for the first CG resource from the BS indicating the second traffic priority (e.g., a high traffic priority or a low traffic priority). In some aspects, the UE may utilize one or more components, such as the processor 1902, the memory 1904, the UL communication module 1908, the transceiver 1910, the modem 1912, and the one or more antennas 1916, to perform the operations at block 2110.

At block 2120, the UE determines whether the first priority is higher than the second priority. In some aspects, the UE may utilize one or more components, such as the processor 1902, the memory 1904, the UL communication module 1908, the transceiver 1910, the modem 1912, and the one or more antennas 1916, to perform the operations at block 2120.

At block 2130, the UE transmits, in response to determining whether the first priority is higher than the second priority, one of the uplink transmission in the first resource or the first CG-PUSCH transmission in the second resource. In some aspects, the UE may utilize one or more components, such as the processor 1902, the memory 1904, the UL communication module 1908, the transceiver 1910, the modem 1912, and the one or more antennas 1916, to perform the operations at block 2130.

At block 2140, the UE refrains from transmitting the other one of the uplink transmission in the first resource or the first CG-PUSCH transmission in the second resource in response to determining whether the first priority is higher than the second priority. In some aspects, the UE may utilize one or more components, such as the processor 1902, the memory 1904, the UL communication module 1908, the transceiver 1910, the modem 1912, and the one or more antennas 1916, to perform the operations at block 2140.

In some aspects, if the UE determines that the first priority is higher than the second priority at block 2120, the UE may transmit the uplink transmission at block 2130 and refrain from transmitting the CG-PUSCH transmission at block 2140. In some aspects, the uplink transmission may include HARQ-ACK information scheduled on the first resource, for example, as discussed above in relation to FIG. 4.

In some aspects, if the UE determines that the first priority is lower than the second priority at block 2120, the UE may transmit the CG-PUSCH transmission at block 2130 and refrain from transmitting the uplink transmission at block 2140. In some aspects, the uplink transmission may include at least one of HARQ-ACK information or CSI, for example, as discussed above in relation to FIGS. 5-6.

In some aspects, the uplink transmission may include a second CG-PUSCH transmission, and the UE may refrain from transmitting the second CG-PUSCH transmission further based on the first CG PUSCH transmission comprising uplink data at block 2140, for example, as discussed above in relation to FIG. 7.

In some aspects, the uplink transmission may include HARQ-ACK information and the first CG-PUSCH transmission may include CG-UCI. The UE may refrain from transmitting the other one of the uplink transmission or the first CG-PUSCH transmission at block 2140 further based on a multiplex configuration for multiplexing the HARQ-ACK information with the CG-UCI of different priorities being disabled. In some aspects, the UE may receive a RRC configuration disabling the multiplex configuration from a BS.

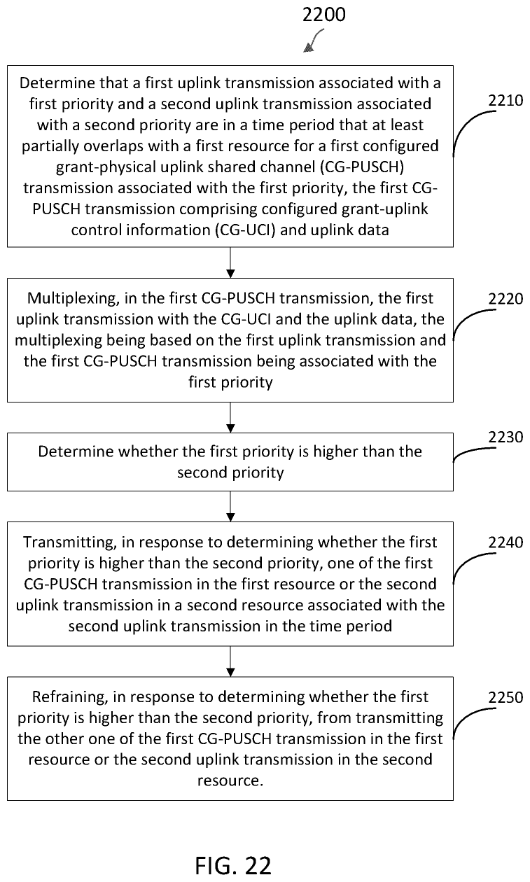

FIG. 22 is a flow diagram of a communication method 2200 according to some aspects of the present disclosure. Aspects of the method 2200 can be executed by a UE, such as the UEs 115 and/or 1900. For example, a UE 1900 may utilize one or more components, such as the processor 1902, the memory 1904, the UL communication module 1908, the transceiver 1910, the modem 1912, and the one or more antennas 1916, to execute the steps of method 2100. The method 2200 may employ similar mechanisms as discussed above with respect to FIGS. 1-3, 8-10, and 18. As illustrated, the method 2200 includes a number of enumerated steps, but aspects of the method 2200 may include additional steps before, after, and in between the enumerated steps. In some aspects, one or more of the enumerated steps may be omitted or performed in a different order.

At block 2210, a UE (e.g., a UE 115 or a UE 1900) determines that a first uplink transmission associated with a first priority and a second uplink transmission associated with a second priority are in a time period that at least partially overlaps with a first resource for a first CG-PUSCH transmission associated with the first priority. The first CG-PUSCH transmission includes CG-UCI and uplink data. In some aspects, the UE may receive schedule(s) for the first uplink transmission from a BS, where the schedule(s) or configuration(s) may indicate the first priority (e.g., a high traffic priority or a low traffic priority) and resource(s) for the uplink transmission. The UE may also receive schedule(s) or configuration(s) for the second uplink transmission from the BS, where the schedule(s) or configuration(s) may indicate the second priority (e.g., a high traffic priority or a low traffic priority) and resource(s) for the second uplink transmission. The UE may further receive a configured grant for the first CG resource from the BS indicating the first traffic priority. In some aspects, the UE may utilize one or more components, such as the processor 1902, the memory 1904, the UL communication module 1908, the transceiver 1910, the modem 1912, and the one or more antennas 1916, to perform the operations at block 2210.

At block 2220, the UE multiplexes, in the first CG-PUSCH transmission, the first uplink transmission with the CG-UCI and the uplink data, the multiplexing being based on the first uplink transmission and the first CG-PUSCH transmission being associated with the first priority. The multiplexing may include mapping UCI for the first uplink transmission to RE(s) in the first resource as discussed above in relation to FIGS. 8-10. In some aspects, the UE may utilize one or more components, such as the processor 1902, the memory 1904, the UL communication module 1908, the transceiver 1910, the modem 1912, and the one or more antennas 1916, to perform the operations at block 2210.

At block 2230, the UE determines whether the first priority is higher than the second priority. In some aspects, the UE may utilize one or more components, such as the processor 1902, the memory 1904, the UL communication module 1908, the transceiver 1910, the modem 1912, and the one or more antennas 1916, to perform the operations at block 2230.

At block 2240, the UE transmits, in response to determining whether the first priority is higher than the second priority, one of the first CG-PUSCH transmission in the first resource or the second uplink transmission in a second resource associated with the second uplink transmission in the time period. In some aspects, the UE may utilize one or more components, such as the processor 1902, the memory 1904, the UL communication module 1908, the transceiver 1910, the modem 1912, and the one or more antennas 1916, to perform the operations at block 2240.

At block 2250, the UE refrains from transmitting the other one of the first CG-PUSCH transmission in the first resource or the second uplink transmission in the second resource in response to determining whether the first priority is higher than the second priority. In some aspects, the UE may utilize one or more components, such as the processor 1902, the memory 1904, the UL communication module 1908, the transceiver 1910, the modem 1912, and the one or more antennas 1916, to perform the operations at block 2250.

In some aspects, if the UE determines that the first priority is lower than the second priority, the UE may transmit the second uplink transmission at block 2240, and refrain from transmitting the first CG-PUSCH transmission at block 2250. In some aspects, the first uplink transmission may include at least one of first HARQ-ACK information or CSI, and wherein the second uplink transmission may include second HARQ-ACK information different from the first HARQ-ACK information, for example, as discussed above in relation to FIG. 8.

In some aspects, if the UE determines that the first priority is higher than the second priority, the UE may transmit the first CG-PUSCH transmission at block 2240, and refrain from transmitting the second uplink transmission at block 2250. In some aspects, the first uplink transmission may include first HARQ-ACK information, and wherein the second uplink transmission may include at least one of CSI or second HARQ-ACK information different from the first HARQ-ACK information, for example, as discussed above in relation to FIGS. 9-10. In some aspects the UE may further multiplex the second HARQ-ACK information with the CSI in the second uplink transmission, and refraining from transmitting the second uplink transmission comprising the second HARQ-ACK information multiplexed with the CSI at block 2250. In some aspects, the second uplink transmission may further include a second CG-PUSCH transmission, the second CG-PUSCH transmission comprising CG-UCI and uplink data. The UE may further multiplex the at least one of the CSI or the second HARQ-ACK information with the CG-UCI and the uplink data in the second CG-PUSCH transmission and refrain from transmitting the second CG-PUSCH transmission comprising the at least one of the CSI or the second HARQ-ACK information multiplexed with the CG-UCI and the uplink data at block 2250.

In some aspects, the first CG-PUSCH transmission may include CG-UCI, and the second uplink transmission may include HARQ-ACK information. The UE may refrain from transmitting the other one of the first CG-PUSCH transmission in the first resource or the second uplink transmission in the second resource at block 2250 further based on a multiplex configuration for multiplexing the HARQ-ACK information with the CG-UCI of different priorities being disabled. In some aspects, the UE may receive an RRC configuration disabling the multiplex configuration from a BS.

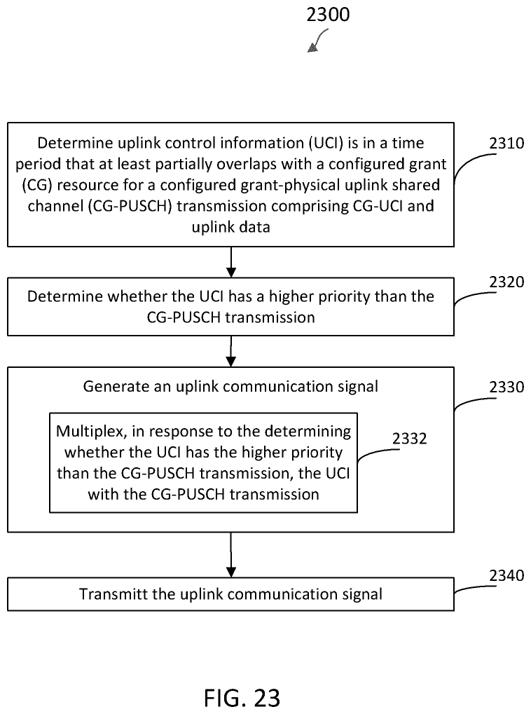

FIG. 23 is a flow diagram of a communication method 2300 according to some aspects of the present disclosure. Aspects of the method 2300 can be executed by a UE, such as the UEs 115 and/or 1900. For example, a UE 1900 may utilize one or more components, such as the processor 1902, the memory 1904, the UL communication module 1908, the transceiver 1910, the modem 1912, and the one or more antennas 1916, to execute the steps of method 2300. The method 2300 may employ similar mechanisms as discussed above with respect to FIGS. 1-3, 11-12, and 18. As illustrated, the method 2300 includes a number of enumerated steps, but aspects of the method 2300 may include additional steps before, after, and in between the enumerated steps. In some aspects, one or more of the enumerated steps may be omitted or performed in a different order.

At block 2310, a UE (e.g., a UE 115 or a UE 1900) determines uplink control information (UCI) is in a time period that at least partially overlaps with a CG resource for a CG-PUSCH transmission comprising CG-UCI and uplink data. In some aspects, the UE may receive schedule(s) or configuration(s) for the uplink transmission from a BS, where the schedule(s) or configuration(s) may indicate the first priority (e.g., a high traffic priority or a low traffic priority) and resource(s) for the uplink transmission. The UE may further receive a configured grant for the CG resource from the BS indicating the second traffic priority (e.g., a high traffic priority or a low traffic priority). In some aspects, the UE may utilize one or more components, such as the processor 1902, the memory 1904, the UL communication module 1908, the transceiver 1910, the modem 1912, and the one or more antennas 1916, to perform the operations at block 2310.

At block 2320, the UE determines whether the UCI has a higher priority than the CG-PUSCH transmission. In some aspects, the UE may utilize one or more components, such as the processor 1902, the memory 1904, the UL communication module 1908, the transceiver 1910, the modem 1912, and the one or more antennas 1916, to perform the operations at block 2320.

At block 2330, the UE generates an uplink communication signal. As part of generating the uplink communication signal, at block 2332, the UE multiplexes, in response to the determining whether the UCI has the higher priority than the CG-PUSCH transmission, the UCI with the CG-PUSCH transmission. In some aspects, the UE may utilize one or more components, such as the processor 1902, the memory 1904, the UL communication module 1908, the transceiver 1910, the modem 1912, and the one or more antennas 1916, to perform the operations at block 2330.

At block 2340, the UE transmits the uplink communication signal. The UE may transmit the uplink communication signal in the CG resource or in a resource for the UCI within the time period depending on whether the UCI has a higher priority than the CG-PUSCH transmission and a number of resources in the CG resource. In some aspects, the UE may utilize one or more components, such as the processor 1902, the memory 1904, the UL communication module 1908, the transceiver 1910, the modem 1912, and the one or more antennas 1916, to perform the operations at block 2340.

In some aspects, the multiplexing at block 2332 may include mapping, in response to determining the UCI has a higher priority than the CG-PUSCH transmission, the UCI to a first set of resources in the CG resource, where the UCI may include hybrid automatic repeat request (HARQ-ACK) information, for example, as discussed above in relation to FIG. 11. In some aspects, the multiplexing at block 2330 may further include mapping, based on a number of remaining resources in the CG resource satisfies a threshold, the CG-PUSCH transmission to one or more of the remaining resources, and the UE may transmitting the uplink communication signal in the CG resource at block 2340. In some aspects, the multiplexing at block 2330 may include further include refraining from mapping the CG-PUSCH transmission to the remaining resources based on a number of remaining resources in the CG resource fails to satisfy a threshold, and the UE may transmit the uplink communication signal in a resource for the UCI within the time period at block 2340.

In some aspects, the multiplexing at block 2330 may include mapping, in response to determining the UCI has a lower priority than the CG-PUSCH transmission, the CG-PUSCH transmission to a first set of resources in the CG resource, where the UCI may include at least one of first hybrid automatic repeat request (HARQ-ACK) information or CSI, for example, as discussed above in relation to FIG. 12. In some aspects, the multiplexing at block 2330 may further include mapping, based on a number of remaining resources in the CG resource satisfies a threshold, the UCI to one or more of the remaining resources, the UE may transmit the uplink communication signal in the CG resource at block 2340. In some aspects, the multiplexing at block 2330 may further include refraining from mapping the UCI to the remaining resources based on a number of remaining resources in the CG resource fails to satisfy a threshold, and the UE may transmitting the uplink communication signal in the CG resource at block 2340.

In some aspects, the UCI may include HARQ-ACK information, and the multiplexing at block 2330 may be further based on a multiplex configuration for multiplexing the HARQ-ACK information and the CG-UCI of different priorities. In some aspects, the UE may receive a RRC configuration enabling the multiplex configuration from the BS.

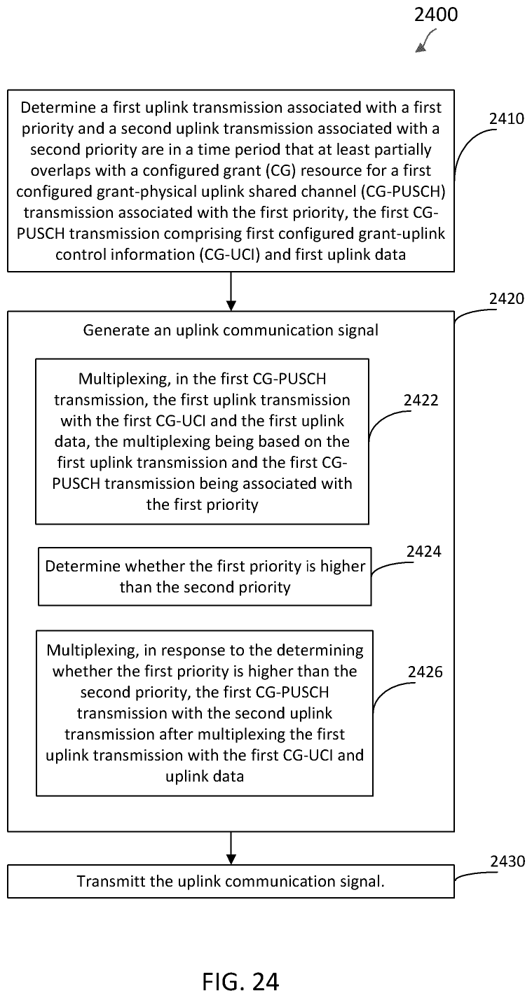

FIG. 24 is a flow diagram of a communication method 2400 according to some aspects of the present disclosure. Aspects of the method 2400 can be executed by a UE, such as the UEs 115 and/or 1900. For example, a UE 1900 may utilize one or more components, such as the processor 1902, the memory 1904, the UL communication module 1908, the transceiver 1910, the modem 1912, and the one or more antennas 1916, to execute the steps of method 2400. The method 2400 may employ similar mechanisms as discussed above with respect to FIGS. 1-3, 13-14, and 18. As illustrated, the method 2400 includes a number of enumerated steps, but aspects of the method 2400 may include additional steps before, after, and in between the enumerated steps. In some aspects, one or more of the enumerated steps may be omitted or performed in a different order.

At block 2410, a UE (e.g., a UE 115 or a UE 1900) determines a first uplink transmission associated with a first priority and a second uplink transmission associated with a second priority are in a time period that at least partially overlaps with a CG resource for a first CG-PUSCH transmission associated with the first priority. The first CG-PUSCH transmission includes first CG-UCI and first uplink data. In some aspects, the UE may receive schedule(s) for the first uplink transmission from a BS, where the schedule(s) or configuration(s) may indicate the first priority (e.g., a high traffic priority or a low traffic priority) and resource(s) for the uplink transmission. The UE may also receive schedule(s) or configuration(s) for the second uplink transmission from the BS, where the schedule(s) or configuration(s) may indicate the second priority (e.g., a high traffic priority or a low traffic priority) and resource(s) for the second uplink transmission. The UE may further receive a configured grant for the first CG resource from the BS indicating the first traffic priority. In some aspects, the UE may utilize one or more components, such as the processor 1902, the memory 1904, the UL communication module 1908, the transceiver 1910, the modem 1912, and the one or more antennas 1916, to perform the operations at block 2410.

At block 2420, the UE generates an uplink communication signal. As part of generating the uplink communication signal, the UE multiplexes, in the first CG-PUSCH transmission, the first uplink transmission with the first CG-UCI and the first uplink data at block 2422, where the multiplexing is based on the first uplink transmission and the first CG-PUSCH transmission being associated with the same first priority. At block 2424, the UE further determines whether the first priority is higher than the second priority. At block 2426, the UE further multiplexes, in response to the determining whether the first priority is higher than the second priority, the first CG-PUSCH transmission with the second uplink transmission after multiplexing the first uplink transmission with the first CG-UCI and uplink data. In some aspects, the UE may utilize one or more components, such as the processor 1902, the memory 1904, the UL communication module 1908, the transceiver 1910, the modem 1912, and the one or more antennas 1916, to perform the operations at block 2420.

At block 2430, the UE transmits the uplink communication signal. The UE may transmit the uplink communication signal in the first CG resource or in a resource for the second uplink transmission within the time period depending on whether the second uplink transmission has a higher priority than the first CG-PUSCH transmission and a number of resources in the first CG resource. In some aspects, the UE may utilize one or more components, such as the processor 1902, the memory 1904, the UL communication module 1908, the transceiver 1910, the modem 1912, and the one or more antennas 1916, to perform the operations at block 2430.

In some aspects, the first priority may be lower than the second priority. In other words, the first CG-PUSCH and the first uplink transmission have a lower priority than the second uplink transmission, for example, as discussed above in relation to FIG. 13. As part of multiplexing the first CG-PUSCH transmission with the second uplink transmission at block 2426, the UE may map the first CG-PUSCH transmission to a first set of resources in the CG resource. In some aspects, as part of multiplexing the first CG-PUSCH transmission with the second uplink transmission at block 2426, the UE may map the second uplink transmission to one or more of the remaining resources based on a number of remaining resources satisfies a threshold, where the second uplink transmission may include hybrid automatic repeat request (HARQ-ACK) information. The UE may transmit the uplink communication signal in the CG resource at block 2430 based on the number of remaining resources satisfies the threshold. In some aspects, as part of multiplexing the first CG-PUSCH transmission with the second uplink transmission at block 2426, the UE may refrain from mapping the second uplink transmission to the remaining resources based on a number of remaining resources fails to satisfy a threshold, where the second uplink transmission may include hybrid automatic repeat request (HARQ-ACK) information. The UE may transmit the second uplink transmission in a resource for the second uplink transmission within the time period based on the first priority being lower than the second priority and the number of remaining resources fails to satisfy the threshold. In some aspects, the first uplink transmission may include at least one of CSI or another HARQ-ACK information. In some aspects, the first uplink transmission may include CSI part 1, CSI part 2, and the another HARQ-ACK information, and as part of multiplexing the first uplink transmission with the CG transmission, the UE removes the CSI part 2 from the second uplink transmission based on a threshold associated with a number of uplink control information (UCI) code blocks in the uplink communication signal.

In some aspects, the first priority may be higher than the second priority. In other words, the first CG-PUSCH and the first uplink transmission have a higher priority than the second uplink transmission, for example, as discussed above in relation to FIG. 14. As part of multiplexing the first CG-PUSCH transmission with the second uplink transmission at block 2426, the UE may map, in response to determining the first priority is higher than the second priority, the first CG-PUSCH transmission to a first set of resources in the CG resource. In some aspects, the second uplink transmission comprising at least one of CSI or HARQ-ACK information, as part of multiplexing the first CG-PUSCH transmission with the second uplink transmission at block 2426, the UE determines whether a number of remaining resources in the CG resource satisfies a threshold associated with a number of coded bits, the number of coded bits being associated with the second uplink transmission. In some aspects, as part of multiplexing the first CG-PUSCH transmission with the second uplink transmission at block 2426, the UE may map, in response to determining the number of remaining resources satisfies the threshold, the second uplink transmission to one or more of the remaining resources. The UE may transmit the uplink communication signal in the CG resource at block 2430. In some aspects, as part of multiplexing the first CG-PUSCH transmission with the second uplink transmission at block 2426, the UE may refrain from mapping the second uplink transmission to the remaining resources in response to determining the number of remaining resources fails to satisfy the threshold. The UE may transmit the uplink communication signal in the CG resource at block 2430. In some aspects, the second uplink transmission may include the CSI and the HARQ-ACK information. As part of generating the uplink communication signal at block 2430, the UE may further multiplex the CSI with the HARQ-ACK information in the second uplink transmission. As part of the determining whether the number of remaining resources satisfies the threshold, the UE may determine whether the number of remaining resources satisfies the threshold, where the threshold associated with the number of coded bits for the second uplink transmission that may include the CSI multiplexed with the HARQ-ACK information. In some aspects, the second uplink transmission may include at least one of CSI or HARQ-ACK information and a second CG-PUSCH transmission comprising second CG-UCI and second uplink data. As part of generating the uplink communication signal, the UE may further multiplex, in the second CG-PUSCH transmission, the at least one of the CSI or the HARQ-ACK information with the second CG-UCI and the second uplink data. As part of multiplexing the first CG-PUSCH transmission with the second uplink transmission at block 2426, the UE may further refrain from mapping the second CG-PUSCH transmission comprising the at least one of the CSI or the HARQ-ACK information multiplexed with the second CG-UCI to a resource configured for the second CG-PUSCH transmission within the time period.

In some aspects, the second uplink transmission may include hybrid automatic repeat request-acknowledgement (HARQ ACK) information, and the multiplexing at block 2426 is further based on a multiplex configuration for multiplexing the HARQ-ACK information and the first CG-UCI of different priorities. In some aspects, the UE may receive an RRC configuration enabling the multiplex configuration from the BS.

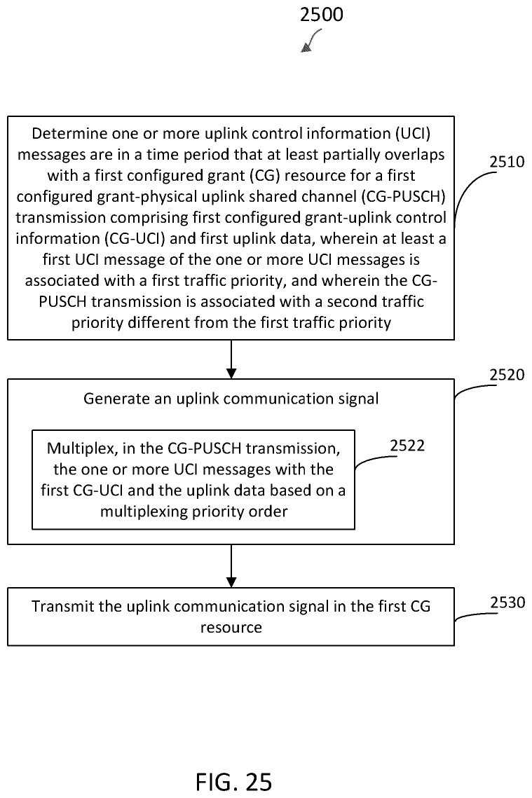

FIG. 25 is a flow diagram of a communication method 2500 according to some aspects of the present disclosure. Aspects of the method 2500 can be executed by a UE, such as the UEs 115 and/or 1900. For example, a UE 1900 may utilize one or more components, such as the processor 1902, the memory 1904, the UL communication module 1908, the transceiver 1910, the modem 1912, and the one or more antennas 1916, to execute the steps of method 2500. The method 2500 may employ similar mechanisms as discussed above with respect to FIGS. 1-3, 15-17, and 18. As illustrated, the method 2500 includes a number of enumerated steps, but aspects of the method 2500 may include additional steps before, after, and in between the enumerated steps. In some aspects, one or more of the enumerated steps may be omitted or performed in a different order.

At block 2510, a UE (e.g., a UE 115 or a UE 1900) determines the one or more uplink control information (UCI) messages are in a time period that at least partially overlaps with a first CG resource for a first CG-PUSCH transmission comprising first CG-UCI and first uplink data, where at least a first UCI message of the one or more UCI messages is associated with a first traffic priority, and wherein the CG-PUSCH transmission is associated with a second traffic priority different from the first traffic priority. In some aspects, the UE may receive schedule(s) for the one or more UCI messages from a BS, where the schedule(s) or configuration(s) may indicate a traffic priority for each UCI message. The UE may further receive a configured grant for the first CG resource from the BS indicating the second traffic priority. In some aspects, the UE may utilize one or more components, such as the processor 1902, the memory 1904, the UL communication module 1908, the transceiver 1910, the modem 1912, and the one or more antennas 1916, to perform the operations at block 2510.

At block 2520, the UE generates an uplink communication signal. As part of generating the uplink communication signal, the UE multiplexes, in the CG-PUSCH transmission, the one or more UCI messages with the first CG-UCI and the uplink data based on a multiplexing priority order at block 2522. In some aspects, the UE may utilize one or more components, such as the processor 1902, the memory 1904, the UL communication module 1908, the transceiver 1910, the modem 1912, and the one or more antennas 1916, to perform the operations at block 2520.

In some aspects, the first traffic priority is higher than the second traffic priority, and the multiplexing priority order from a highest multiplexing priority to a lowest multiplexing priority may include first hybrid automatic repeat request (HARQ-ACK) information associated with the first traffic priority, at least one of second HARQ-ACK information associated with the second traffic priority or the first CG-UCI associated with the second traffic priority, CSI part 1, CSI part 2, and the first uplink data associated with the second traffic priority, for example, as discussed above in relation to FIG. 15. Additionally, the first UCI message may include the first HARQ-ACK information, and a second UCI message of the one or more UCI message may include at least one of the second HARQ-ACK information, the CSI part 1, or the CSI part 2. In some aspects, the multiplexing may include mapping the first UCI message to a first set of resources in the first CG resource based on the HARQ-ACK information having the highest multiplexing priority.

In some aspects, the first traffic priority is lower than the second traffic priority, and the multiplexing priority order from the highest multiplexing priority to the lowest multiplexing priority may include at least one of first hybrid automatic repeat request (HARQ-ACK) information associated with the second traffic priority or the first CG-UCI associated with second traffic priority, the first uplink data associated with the second traffic priority, second HARQ-ACK information associated with the first traffic priority, CSI part 1, CSI part 2, for example, as discussed above in relation to FIGS. 16 and/or 17. Additionally, the first UCI message may include at least one of the second HARQ-ACK information, the CSI part 1, or the CSI part 2, and a second UCI message of the or more UCI messages may include the first HARQ-ACK information. In some aspects, the multiplexing may include mapping at least one of the first HARQ-ACK information or the first CGI to a first set of resources in the first CG resource.

At block 2530, the UE transmits the uplink communication signal in the first CG resource.

In some aspects, as part of multiplexing the one or more UCI messages with the first CG-UCI and the uplink data at block 2520, the UE may multiplex each remaining message of the one or more UCI messages into the first CG-PUSCH transmission by determining whether a number of remaining resources in the first CG resource satisfies a threshold associated with a number of coded bits for the remaining message, and mapping, in response to determining the number of remaining number satisfies the threshold, the remaining message to one or more of the remaining resources. In some aspects, the UE may utilize one or more components, such as the processor 1902, the memory 1904, the UL communication module 1908, the transceiver 1910, the modem 1912, and the one or more antennas 1916, to perform the operations at block 2530.

In some aspects, as part of multiplexing the one or more UCI messages with the first CG-UCI and the uplink data at block 2520, the UE may determine whether a number of remaining resources in the first CG resource satisfies a threshold associated with a number of coded bits for the first CG-UCI, and mapping, in response to determining the number of remaining number satisfies the threshold, the first CG-UCI to one or more of the remaining resources.

In some aspects, as part of multiplexing the one or more UCI messages with the first CG-UCI and the uplink data at block 2520, the UE may determine whether a number of remaining resources in the first CG resource satisfies a threshold associated with a number of coded bits for the first uplink data, and mapping, in response to determining the number of remaining number satisfies the threshold, the first uplink data to one or more of the remaining resources.

In some aspects, the UE may further generate a second CG-PUSCH transmission associated with the first traffic priority for transmission in a second CG resource. The UE may further determine that the second CG resource at least partially overlaps with the first CG resource and the second CG-PUSCH transmission being associated with the first traffic priority lower than the second traffic priority. The UE may further discard, based the second CG resource being at least partially overlapping with the first CG resource, the second CG-PUSCH transmission before multiplexing the one or more UCI messages with the first CG-UCI and the uplink data, for example, as discussed above in relation to FIG. 17.

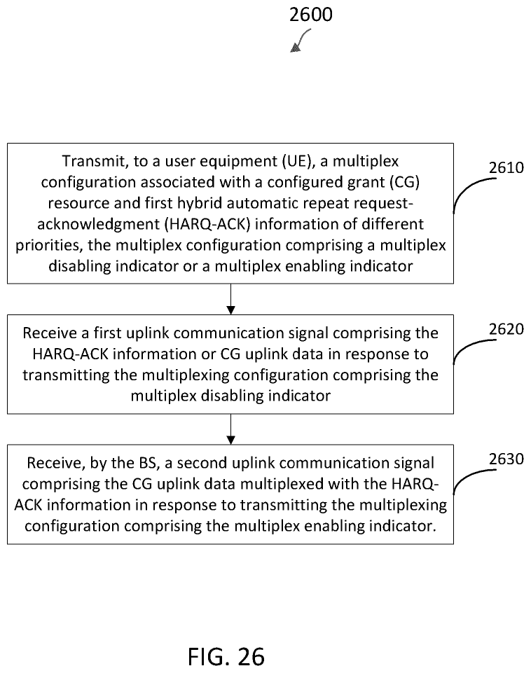

FIG. 26 is a flow diagram of a communication method 2600 according to some aspects of the present disclosure. Aspects of the method 2600 can be executed by a BS, such as the UEs 105 and/or 2000. For example, a BS 2000 may utilize one or more components, such as the processor 2002, the memory 2004, the UL communication module 2008, the transceiver 2010, the modem 2012, and the one or more antennas 2016, to execute the steps of method 2600. The method 2600 may employ similar mechanisms as discussed above with respect to FIGS. 1-18. As illustrated, the method 2600 includes a number of enumerated steps, but aspects of the method 2600 may include additional steps before, after, and in between the enumerated steps. In some aspects, one or more of the enumerated steps may be omitted or performed in a different order.

At block 2610, a BS (e.g., a BS 105 or a BS 2000) transmits, to a UE (e.g., a UE 115 or a UE 1900), a multiplex configuration associated with a CG resource and first hybrid automatic repeat request-acknowledgment (HARQ-ACK) information of different priorities, the multiplex configuration comprising a multiplex disabling indicator or a multiplex enabling indicator. In some aspects, the BS may utilize one or more components, such as the processor 2002, the memory 2004, the UL communication module 2008, the transceiver 2010, the modem 2012, and the one or more antennas 2016, to perform the operations at block 2610.

At block 2620, the BS receives a first uplink communication signal comprising the HARQ-ACK information or CG uplink data in response to transmitting the multiplexing configuration comprising the multiplex disabling indicator. In some aspects, the BS may utilize one or more components, such as the processor 2002, the memory 2004, the UL communication module 2008, the transceiver 2010, the modem 2012, and the one or more antennas 2016, to perform the operations at block 2620.

At block 2630, the BS receives a second uplink communication signal comprising the CG uplink data multiplexed with the HARQ-ACK information in response to transmitting the multiplexing configuration comprising the multiplex enabling indicator. In some aspects, the BS may utilize one or more components, such as the processor 2002, the memory 2004, the UL communication module 2008, the transceiver 2010, the modem 2012, and the one or more antennas 2016, to perform the operations at block 2630.

In some aspects, the HARQ-ACK information is associated with a higher priority than the CG resource. In some aspects, the second uplink communication signal may further include UCI associated with the same priority as the CG uplink data, wherein the UCI may include at least one of another HARQ-ACK information or CSI.

In some aspects, the HARQ-ACK information is associated with a lower priority than the CG resource. In some aspects, the second uplink communication signal may further include CSI associated with same priority as the HARQ-ACK information.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C). The terms “about” or “approximately” may be used to denote a range of +/−2%, unless specified otherwise.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method of wireless communication performed by a user equipment (UE), the method comprising:
determining that a first resource for an uplink transmission associated with a first priority at least partially overlaps with a second resource for a first configured grant-physical uplink shared channel (CG-PUSCH) transmission associated with a second priority different from the first priority;
determining whether the first priority is higher than the second priority;
transmitting, in response to determining whether the first priority is higher than the second priority, one of the uplink transmission in the first resource or the first CG-PUSCH transmission in the second resource; and
refraining, in response to determining whether the first priority is higher than the second priority, from transmitting the other one of the uplink transmission in the first resource or the first CG-PUSCH transmission in the second resource.

2. The method of claim 1, wherein:
the transmitting comprises:
transmitting, in response to determining the first priority is higher than the second priority, the uplink transmission; and
the refraining comprises:
refraining, in response to determining the first priority is higher than the second priority, from transmitting the first CG-PUSCH transmission.

3. The method of claim 2, wherein the uplink transmission comprises hybrid automatic repeat request-acknowledgement (HARQ-ACK) information scheduled on the first resource.

4. The method of claim 1, wherein:
the transmitting comprises:
transmitting, in response to determining the first priority is lower than the second priority, the first CG-PUSCH transmission; and
the refraining comprises:
refraining, in response to determining the first priority is lower than the second priority, the uplink transmission.

5. The method of claim 4, wherein the uplink transmission comprises at least one of hybrid automatic repeat request-acknowledgement (HARQ-ACK) information or channel state information (CSI).

6. The method of claim 1, wherein:
the uplink transmission comprises a second CG-PUSCH transmission; and
the refraining from transmitting the uplink transmission further comprises:
refraining from transmitting the second CG-PUSCH transmission further based on the first CG-PUSCH transmission comprising uplink data.

7. The method of claim 1, wherein:
the uplink transmission comprises hybrid automatic repeat request-acknowledgement (HARQ-ACK) information;
the first CG-PUSCH transmission comprises configured grant-uplink control information (CG-UCI); and
the refraining from transmitting the other one of the uplink transmission or the first CG-PUSCH transmission is further based on a multiplex configuration for multiplexing the HARQ-ACK information with the CG-UCI of different priorities being disabled.

8. The method of claim 7, further comprising:
receiving, from a base station (B S), a radio resource control (RRC) configuration disabling the multiplex configuration.

9. A method of wireless communication performed by a first user equipment (UE), the method comprising:
determining that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission comprising configured grant-uplink control information (CG-UCI) and uplink data;
multiplexing, in the first CG-PUSCH transmission, the first uplink transmission with the CG-UCI and the uplink data, the multiplexing being based on the first uplink transmission and the first CG-PUSCH transmission being associated with the first priority;
determining whether the first priority is higher than the second priority;
transmitting, in response to determining whether the first priority is higher than the second priority, one of the first CG-PUSCH transmission in the first resource or the second uplink transmission in a second resource associated with the second uplink transmission in the time period; and
refraining, in response to determining whether the first priority is higher than the second priority, from transmitting the other one of the first CG-PUSCH transmission in the first resource or the second uplink transmission in the second resource.

10. The method of claim 9, wherein:
the transmitting comprises:
transmitting, in response to determining the first priority is lower than the second priority, the second uplink transmission; and
the refraining comprises:
refraining from transmitting the first CG-PUSCH transmission in response to determining the first priority is lower than the second priority.

11. The method of claim 10, wherein the first uplink transmission comprises at least one of first hybrid automatic repeat request-acknowledgement (HARQ-ACK) information or channel state information (CSI), and wherein the second uplink transmission comprises second HARQ-ACK information different from the first HARQ-ACK information.

12. The method of claim 9, wherein:
the transmitting comprises:
transmitting, in response to determining the first priority is higher than the second priority, the first CG-PUSCH transmission; and
the refraining comprises:
refraining from transmitting the second uplink transmission in response to determining the first priority is higher than the second priority.

13. The method of claim 12, wherein the first uplink transmission comprises first hybrid automatic repeat request-acknowledgement (HARQ-ACK) information, and wherein the second uplink transmission comprises at least one of channel state information (CSI) or second HARQ-ACK information different from the first HARQ-ACK information.

14. The method of claim 13, further comprising:
multiplexing the second HARQ-ACK information with the CSI in the second uplink transmission,
wherein the refraining from transmitting the second uplink transmission comprises:
refraining from transmitting the second uplink transmission comprising the second HARQ-ACK information multiplexed with the CSI.

15. (canceled)

16. The method of claim 9, wherein:
the first CG-PUSCH transmission comprises configured grant-uplink control information (CG-UCI);
the second uplink transmission comprises hybrid automatic repeat request-acknowledgement (HARQ-ACK) information; and
the refraining from transmitting the other one of the first CG-PUSCH transmission in the first resource or the second uplink transmission in the second resource is further based on a multiplex configuration for multiplexing the HARQ-ACK information with the CG-UCI of different priorities being disabled.

17-54. (canceled)

55. A user equipment (UE) comprising:
a processor configured to:
determine that a first resource for an uplink transmission associated with a first priority at least partially overlaps with a second resource for a first configured grant-physical uplink shared channel (CG-PUSCH) transmission associated with a second priority different from the first priority; and
determine whether the first priority is higher than the second priority; and
a transceiver configured to:
transmit, in response to determining whether the first priority is higher than the second priority, one of the uplink transmission in the first resource or the first CG-PUSCH transmission in the second resource; and
refrain, in response to determining whether the first priority is higher than the second priority, from transmitting the other one of the uplink transmission in the first resource or the first CG-PUSCH transmission in the second resource.

56. The UE of claim 55, wherein:
the transceiver configured to transmit the one of the uplink transmission or the first CG-PUSCH transmission is configured to:
transmit, in response to determining the first priority is higher than the second priority, the uplink transmission; and
the transceiver configured to refrain from transmitting the other one of the uplink transmission or the first CG-PUSCH transmission is configured to:
refraining, in response to determining the first priority is higher than the second priority, from transmitting the first CG-PUSCH transmission.

57. The UE of claim 56, wherein the uplink transmission comprises hybrid automatic repeat request-acknowledgement (HARQ-ACK) information scheduled on the first resource.

58. The UE of claim 55, wherein:
the transceiver configured to transmit the one of the uplink transmission or the first CG-PUSCH transmission is configured to:
transmit, in response to determining the first priority is lower than the second priority, the first CG-PUSCH transmission; and
the transceiver configured to refrain from transmitting the other one of the uplink transmission or the first CG-PUSCH transmission is configured to:
refrain, in response to determining the first priority is lower than the second priority, the uplink transmission.

59. The UE of claim 58, wherein the uplink transmission comprises at least one of hybrid automatic repeat request-acknowledgement (HARQ-ACK) information or channel state information (CSI).

60. The UE of claim 55, wherein:
the uplink transmission comprises a second CG-PUSCH transmission; and
the transceiver configured to refrain from transmitting the other one of the uplink transmission or the first CG-PUSCH transmission is configured to:
refraining from transmitting the second CG-PUSCH transmission further based on the first CG-PUSCH transmission comprising uplink data.

61. The UE of claim 55, wherein:
the uplink transmission comprises hybrid automatic repeat request-acknowledgement (HARQ-ACK) information;
the first CG-PUSCH transmission comprises configured grant-uplink control information (CG-UCI); and
the transceiver configured to refrain from transmitting the other one of the uplink transmission or the first CG-PUSCH transmission is configured to:
refrain from transmitting the other one of the uplink transmission or the first CG-PUSCH transmission further based on a multiplex configuration for multiplexing the HARQ-ACK information with the CG-UCI of different priorities being disabled.

62. The UE of claim 61, wherein the transceiver is further configured to:
receive, from a base station (BS), a radio resource control (RRC) configuration disabling the multiplex configuration.

63. A user equipment (UE) comprising:
a processor configured to:
determine that a first uplink transmission associated with a first priority and a second uplink transmission associated with a second priority are in a time period that at least partially overlaps with a first resource for a first configured grant-physical uplink shared channel (CG-PUSCH) transmission associated with the first priority, the first CG-PUSCH transmission comprising configured grant-uplink control information (CG-UCI) and uplink data;
multiplex, in the first CG-PUSCH transmission, the first uplink transmission with the CG-UCI and the uplink data, the multiplexing being based on the first uplink transmission and the first CG-PUSCH transmission being associated with the first priority;
determine whether the first priority is higher than the second priority; and
a transceiver configured to:
transmit, in response to determining whether the first priority is higher than the second priority, one of the first CG-PUSCH transmission in the first resource or the second uplink transmission in a second resource associated with the second uplink transmission in the time period; and
refrain, in response to determining whether the first priority is higher than the second priority, from transmitting the other one of the first CG-PUSCH transmission in the first resource or the second uplink transmission in the second resource.

64. The UE of claim 63, wherein:
the transceiver configured to transmit the one of the first CG-PUSCH transmission or the second uplink transmission is configured to:
transmit, in response to determining the first priority is lower than the second priority, the second uplink transmission; and
the transceiver configured to refrain from transmitting the other one of the first CG-PUSCH transmission or the second uplink transmission is configured to:
refrain from transmitting the first CG-PUSCH transmission in response to determining the first priority is lower than the second priority.

65. The UE of claim 64, wherein the first uplink transmission comprises at least one of first hybrid automatic repeat request-acknowledgement (HARQ-ACK) information or channel state information (CSI), and wherein the second uplink transmission comprises second HARQ-ACK information different from the first HARQ-ACK information.

66. The UE of claim 63, wherein:
the transceiver configured to transmit the one of the first CG-PUSCH transmission or the second uplink transmission is configured to:
transmitting, in response to determining the first priority is higher than the second priority, the first CG-PUSCH transmission; and
the transceiver configured to refrain from transmitting the other one of the first CG-PUSCH transmission or the second uplink transmission is configured to:
refrain from transmitting the second uplink transmission in response to determining the first priority is higher than the second priority.

67. The UE of claim 66, wherein the first uplink transmission comprises first hybrid automatic repeat request-acknowledgement (HARQ-ACK) information, and wherein the second uplink transmission comprises at least one of channel state information (CSI) or second HARQ-ACK information different from the first HARQ-ACK information.

68. The UE of claim 67, wherein the processor is further configured to:
multiplex the second HARQ-ACK information with the CSI in the second uplink transmission,
the transceiver configured to refrain from transmitting the second uplink transmission is configured to:
refrain from transmitting the second uplink transmission comprising the second HARQ-ACK information multiplexed with the CSI.

69. (canceled)

70. The UE of claim 63, wherein:
the first CG-PUSCH transmission comprises configured grant-uplink control information (CG-UCI);
the second uplink transmission comprises hybrid automatic repeat request-acknowledgement (HARQ-ACK) information; and
the transceiver configured to refrain from transmitting the other one of the first CG-PUSCH transmission or the second uplink transmission is configured to:
refrain from transmitting the other one of the first CG-PUSCH transmission in the first resource or the second uplink transmission in the second resource further based on a multiplex configuration for multiplexing the HARQ-ACK information with the CG-UCI of different priorities being disabled.

71-216. (canceled)
